(19) United States
(12) Patent Application Publication
(10) Pub. No.: US 2025/0286783 A1
(43) Pub. Date: Sep. 11, 2025

(54) ACTIVE BANDWIDTH PARTS SUPPORT FOR FRAGMENTED CARRIERS

(71) Applicant: Apple Inc., Cupertino, CA (US)

(72) Inventors: Xiang Chen, Campbell, CA (US); Jie Cui, San Jose, CA (US); Yang Tang, San Jose, CA (US); Haitong Sun, Saratoga, CA (US); Qiming Li, Beijing (CN); Dawei Zhang, Saratoga, CA (US); Sigen Ye, San Diego, CA (US); Manasa Raghavan, Sunnyvale, CA (US); Yuexia Song, Beijing (CN)

(73) Assignee: Apple Inc., Cupertino, CA (US)

(21) Appl. No.: 19/048,757

(22) Filed: Feb. 7, 2025

Related U.S. Application Data
(60) Provisional application No. 63/563,266, filed on Mar. 8, 2024.

(51) Int. Cl. H04L 41/0896; H04W 72/0453; H04W 72/1268

(52) U.S. Cl. CPC H04L 41/0896; H04W 72/0453; H04W 72/1268

(57) ABSTRACT

The present application relates to devices and components including apparatus. systems, and methods to support two or more active bandwidth parts in cells of wireless communication systems.

### CROSS-REFERENCE TO RELATED APPLICATIONS

This application claims priority to U.S. provisional application No. 63/563,266, entitled “Active Bandwidth Parts Support for Fragmented Carriers” filed on Mar. 3, 2024, the disclosure of which is incorporated by reference herein in its entirety for all purposes.

### TECHNICAL FIELD

The present application relates to the field of wireless technologies and, in particular, to approaches for multiple active bandwidth parts support for fragmented carriers.

### BACKGROUND

Third Generation Partnership Project (3GPP) networks allow for transmissions over a variety of frequencies. For example, the 3GPP networks may have a defined bandwidth in which communications can be transmitted. The entire bandwidth can be broken down into bandwidth parts, where each of the bandwidth parts can be utilized for different purposes, different communications, and/or different operators. In legacy approaches, four bandwidth parts can be configured for a cell. Although four bandwidth parts can be configured, only one bandwidth part could be active for a cell at a time.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates example fragmented carrier arrangements in accordance with some embodiments.

FIG. 5 illustrates an example fragmented spectrum arrangement in accordance with some embodiments.

FIG. 6 illustrates example scheduling arrangements in accordance with some embodiments.

FIG. 7 illustrates a channel state information (CSI) resource configuration (CSI-ResourceConfig) in accordance with some embodiments.

FIG. 8 illustrates an example configurable subband size table in accordance with some embodiments.

FIG. 9 illustrates an example bandwidth part (BWP) arrangement in accordance with some embodiments.

FIG. 10 illustrates an example BWP arrangement in accordance with some embodiments.

FIG. 11 illustrates example scheduling arrangements in accordance with some embodiments.

FIG. 12 illustrates example BWP indicator arrangements in accordance with some embodiments.

FIG. 13 illustrates example virtual resource block (VRB) to physical resource block (PRB) mappings for interleaved cases in accordance with some embodiments.

FIG. 14 illustrates an example non-interleaved mapping in accordance with some embodiments.

FIG. 15 illustrates an example signaling chart in accordance with some embodiments.

FIG. 16 illustrates an example procedure for configuring operation of two or more BWPs in a cell in accordance with some embodiments.

FIG. 17 illustrates an example procedure for determining a configuration for two or more active BWPs in a cell in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

As bandwidth part operation has been implemented within third generation partnership project (3GPP) networks, there have been instances where multiple bandwidth parts with a cell have been assigned to a same operator, to the same devices, and/or for the same operations. In some instances, the bandwidth parts assigned to the same operator, to the same devices, and/or the for the same operations may be separated by other bandwidths parts, such that there may be other frequencies between the bandwidth parts assigned to the same operator, the same device, and/or the same operations.

In legacy approaches, only one bandwidth part could be active at a time within a cell for uplink and downlink. Having more than one bandwidth part active for uplink and downlink at a time within a cell could allow for more transmissions and/or data to be exchanged during a time period. For example, having two bandwidth parts active for uplink during a time period may allow for more uplink transmissions and/or uplink data to be exchanged during the time period than having only one of the bandwidth parts active. Having two bandwidth parts active for downlink during a time period may allow for more downlink transmissions and/or downlink data to be exchanged during the time period than having only one of the bandwidth parts active. Approaches described throughout this disclosure can be utilized for facilitating more than one bandwidth part being active within a cell at a time.

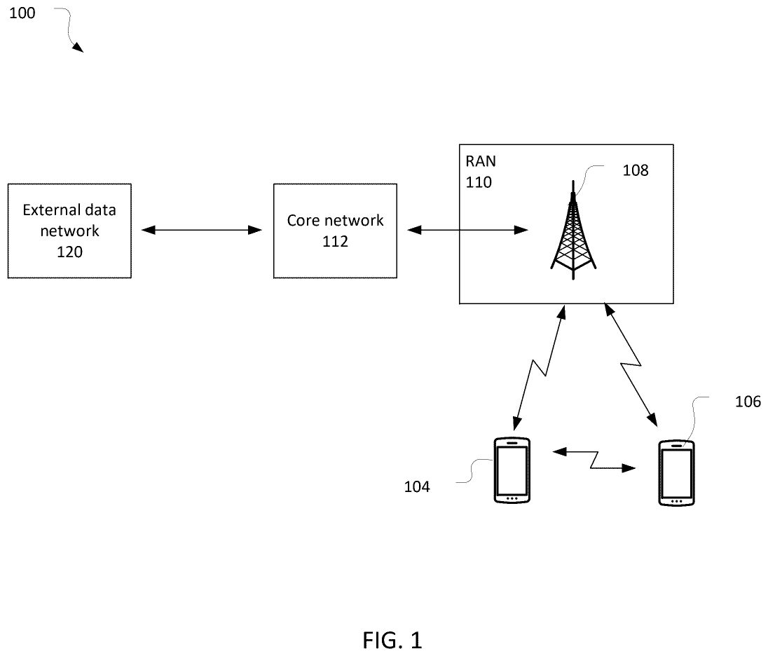

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

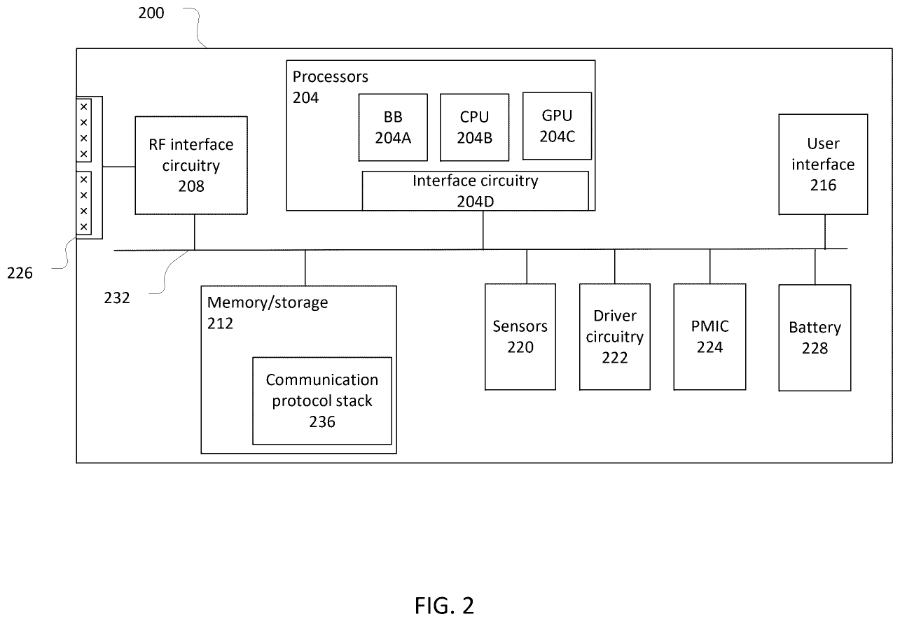

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

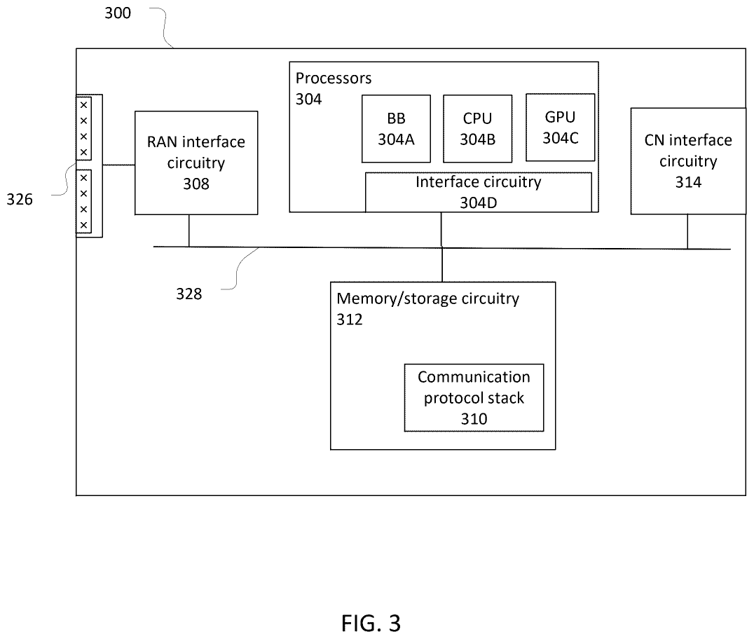

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

Approaches described herein may facilitate having two active bandwidth parts (BWPs) within a cell. For example, the approaches may provide uplink (UL) and channel state information (CSI) support of two active BWPs for fragmented carrier. In release 19 (R19), support for fragmented carriers in the downlink (DL) may be considered. For example, fragmented intra-band blocks as a single component carrier (CC) in the DL may be considered. The scope may be limited to frequency division duplex (FDD) bands, where individual DL bandwidth is less than or equal to 100 megahertz (MHz). The feasibility of using a single reception (Rx) chain per fragmented FDD band may be evaluated, while the near-far problem and unwanted emissions implications can be considered.

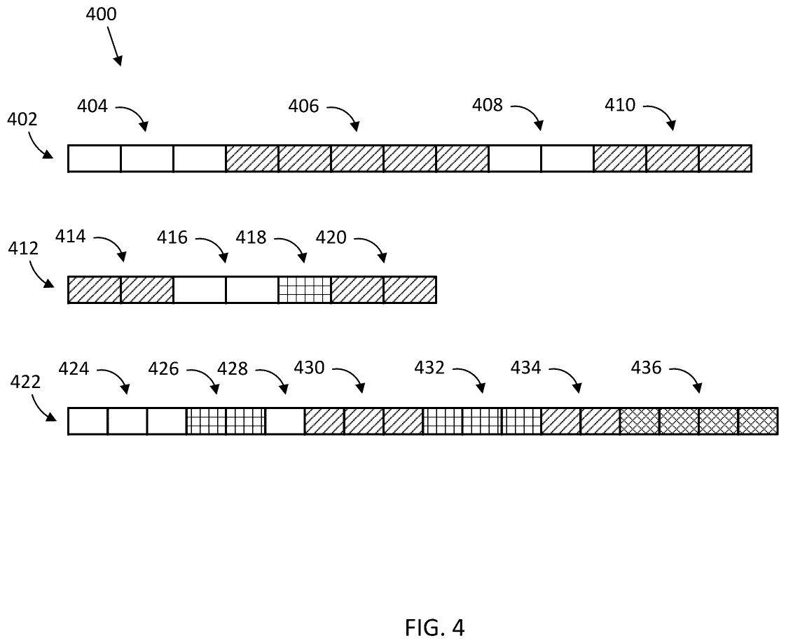

FIG. 4 illustrates example fragmented carrier arrangements 400 in accordance with some embodiments. The fragmented carrier arrangements 400 represent assignments of frequency blocks that results in fragmented carriers (separated by other carriers in the frequency domain) being assigned to the same operator, to the same devices, and/or for the same operations. The fragmented carriers, in the frequency domain, can define multiple BWPs with a bandwidth of operation, where each of the BWPs may be assigned to operators, devices, and/or to particular operations, and consist of one or more contiguous frequency blocks. Approaches described herein may facilitate more than one of the BWPs being active for a cell. For brevity, the frequency blocks are described as being assigned to operators, although it should be understood that the same features could be implemented for frequency blocks assigned to devices, and/or for particular operations.

The fragmented carrier arrangements 400 include a first fragmented carrier arrangement 402. The first fragmented carrier arrangement 402 may be an example PCS (n25) fragmented spectrum arrangement. Each of the rectangles in the first fragmented carrier arrangement 402 may represent a frequency block. Each of the rectangles with a same fill can be assigned to a same operator forming one carrier.

In the illustrated embodiment, a first group of frequency blocks are assigned to a first operator (or unassigned), as being shown by the frequency blocks having no fill. The first group of frequency blocks may form a first BWP 404 including the first group of frequency blocks. A second group of frequency blocks are assigned to a second operator, as being shown by the frequency blocks having a diagonal line fill. The second group of frequency blocks may form a second BWP 406 including the second group of frequency blocks. A third group of frequency blocks are assigned to the first operator (or unassigned), as being shown by the frequency blocks having no fill. The third group of frequency blocks may form a third BWP 408 including the third group of frequency blocks. A fourth group of frequency blocks are assigned to the second operator, as being shown by the frequency blocks having the diagonal line fill. The fourth group of frequency blocks may form a fourth BWP 410 including the fourth group of frequency blocks.

The second BWP 406 and the fourth BWP 410 may be separated in the frequency domain by the third BWP 408. However, the second BWP 406 and the fourth BWP 410 being assigned to the second operator may allow the second operator to utilize the frequency blocks within the second BWP 406 and the fourth BWP 410 as a single carrier, which is called fragmented carrier as second BWP 406 and the fourth BWP 410 are separated in the frequency domain.

The fragmented carrier arrangements 400 include a second fragmented carrier arrangement 412. The second fragmented carrier arrangement 412 may be an example BRS (n7) fragmented spectrum arrangement. Each of the rectangles in the second fragmented carrier arrangement 412 may represent a frequency block. Each of the rectangles with a same fill can be assigned to a same operator.

In the illustrated embodiment, a first group of frequency blocks are assigned to a first operator, as being shown by the frequency blocks having a diagonal line fill. The first group of frequency blocks may form a first BWP 414 including the first group of frequency blocks. A second group of frequency blocks are assigned to a second operator (or unassigned), as being shown by the frequency blocks having no fill. The second group of frequency blocks may form a second BWP 416 including the second group of frequency blocks. A third group of frequency blocks are assigned to a third operator, as being shown by the frequency blocks having a crosshatch fill. The third group of frequency blocks may form a third BWP 418 including the third group of frequency blocks. A fourth group of frequency blocks are assigned to the first operator, as being shown by the frequency blocks having the diagonal line fill. The fourth group of frequency blocks may form a fourth BWP 420 including the fourth group of frequency blocks.

The first BWP 414 and the fourth BWP 420 may be separated in the frequency domain by the third BWP 418 and the fourth BWP 420. However, the first BWP 414 and the fourth BWP 420 being assigned to the first operator may allow the first operator to utilize the frequency blocks within the first BWP 414 and the fourth BWP 420 forming one fragmented carrier.

The fragmented carrier arrangements 400 include a third fragmented carrier arrangement 422. The third fragmented carrier arrangement 422 may be an example AWS1/3/4 (n66) fragmented spectrum arrangement. Each of the rectangles in the third fragmented carrier arrangement 422 may represent a frequency block. Each of the rectangles with a same fill can be assigned to a same operator.

In the illustrated embodiment, a first group of frequency blocks are assigned to a first operator (or unassigned), as being shown by the frequency blocks having no fill. The first group of frequency blocks may form a first BWP 424 including the first group of frequency blocks. A second group of frequency blocks are assigned to a second operator, as being shown by the frequency blocks having a crosshatch fill. The second group of frequency blocks may form a second BWP 426 including the second group of frequency blocks. A third group of frequency blocks are assigned to the first operator (or unassigned), as being shown by the frequency blocks having no fill. The third group of frequency blocks may form a third BWP 428 including the third group of frequency blocks. A fourth group of frequency blocks are assigned to a third operator, as being shown by the frequency blocks having a diagonal line fill. The fourth group of frequency blocks may form a fourth BWP 430 including the fourth group of frequency blocks. A fifth group of frequency blocks are assigned to the second operator, as being shown by the frequency blocks having the crosshatch fill. The fifth group of frequency blocks may form a fifth BWP 432 including the fifth group of frequency blocks. A sixth group of frequency blocks are assigned to the third operator, as being shown by the frequency blocks having the diagonal line fill. The sixth group of frequency blocks may form a sixth BWP 434 including the sixth group of frequency blocks. A seventh group of frequency blocks are assigned to a fourth operator, as being shown by the frequency blocks having the diagonal crosshatch fill. The seventh group of frequency blocks may form a seventh BWP 436 including the seventh group of frequency blocks.

The fourth BWP 430 and the sixth BWP 434 may be separated in the frequency domain by the fifth BWP 432. However, the fourth BWP 430 and the sixth BWP 434 being assigned to the third operator may allow the third operator to utilize the frequency blocks within the fourth BWP 430 and the sixth BWP 434 forming one fragmented carrier.

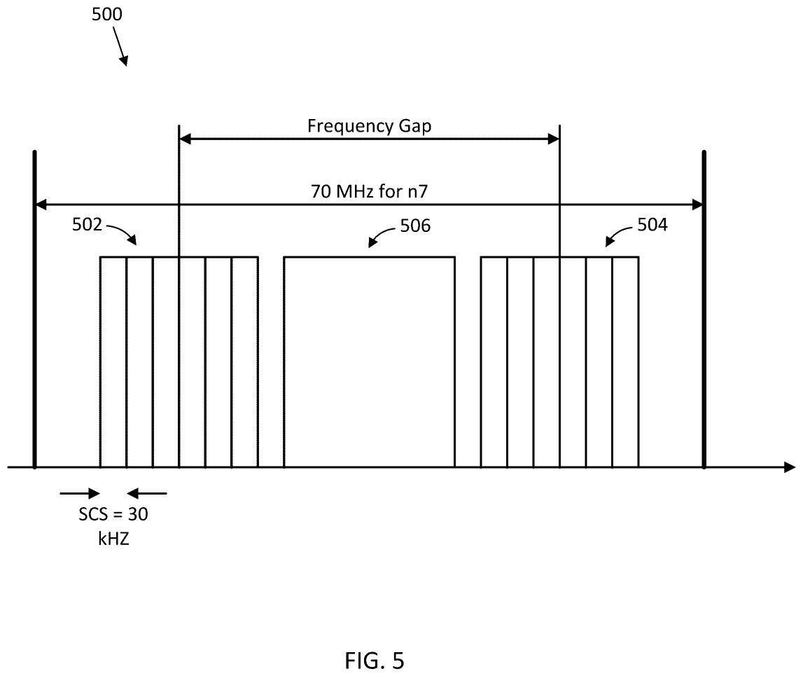

FIG. 5 illustrates an example fragmented spectrum arrangement 500 in accordance with some embodiments. For example, the fragmented spectrum arrangement 500 illustrates an example of fragmented carrier that can be assigned to a same carrier.

The fragmented spectrum arrangement 500 may include a first block 502 of frequency blocks and a second block 504 of frequency blocks. The first block 502 and the second block 504 may be 20 megahertz (MHZ) fragmented blocks within a 70 MHz downlink (DL) n7 bandwidth. The n7 bandwidth may have a bandwidth of 70 MHz. The first block 502 and the second block 504 may be assigned to a same operator. The first block 502 and the second block 504 may be separated in the frequency domain, where a frequency gap exists between the first block 502 and the second block 504. In some instances, the frequency gap may not be multiple resource blocks (RBs).

There is likely other operators operating in the gap between the two adjacent frequency blocks. For example, a channel 506 from another operator may be located in the gap between the first block 502 and the second block 504. Coexistence with the other operator's operation needs to be ensured. In particular, a first operator may be able to utilize the first block 502 and the second block 504, while a second operator may be able to utilize the channel 506. Transmissions by the first operator in the first block 502 and the second block 504 may coexist with transmissions by the second operator in the channel 506.

While the illustrated embodiment is illustrated with a 70 MHz DL n7 bandwidth, other embodiments may have other bandwidths. For example, other embodiments may have an n25 band that is 25 MHz wide, where likely a 70 MHz approach would work too. Other embodiments may have an n66 band that is 90 MHz wide, where a 90 MHz profile is needed. Further, other embodiments may have an n26 band that is 35 MHz wide, where a 35 or 40 MHz profile is needed.

A bandwidth part (BWP) concept may be introduced for new radio (NR) to allow user equipment (UE) to only support smaller channel bandwidth than system bandwidth supported by a base station (BS) and also save power. A BWP may be a subset of contiguous common resource blocks (RBs). For a UE, while up to four BWP can be configured for a serving cell, there is at most one active DL BWP and at most one active uplink (UL) BWP at a given time in legacy approaches. At a given time, up to 4 BWPs can be configured to a UE and only one BWP is active. A UE may be allowed to support two (or more) active BWPs to support fragmented carrier in approaches described herein.

In this disclosure, the one or more following approaches may be implemented in embodiments presented. The approaches may include UL scheduling and physical uplink shared channel (PUSCH) frequency domain resource allocation, power headroom report (PHR) and UE capability on radio frequency (RF) architecture, physical uplink control channel (PUCCH)/PUSCH/sounding reference signal (SRS) frequency hopping, PUCCH/SRS frequency domain resource allocation, and/or channel state information (CSI).

UL scheduling approaches for two or more active BWPs are described herein. The UL scheduling approaches may be utilized for having two or more active BWPs for fragmented carriers within a cell.

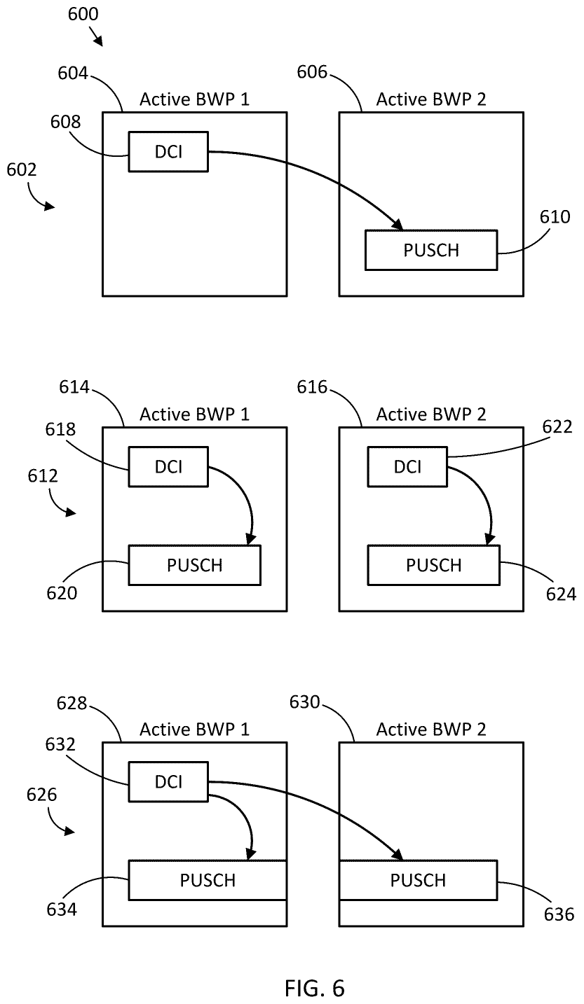

For PUSCH scheduling and hybrid automatic repeat request (HARQ) operation, in terms of the PUSCH scheduling the following may be implemented. For PUSCH frequency domain resource allocation (FDRA), a first option (which may be referred to as “option 1”) or a second option (which may be referred to as “option 2) may be implemented. FIG. 6 illustrates example scheduling arrangements 600 in accordance with some embodiments. The scheduling arrangements 600 may illustrate features of the first option and the second option for the PUSCH FDRA in accordance with some embodiments.

For option 1, FDRA of each PUSCH may only overlap with one active BWP. For scheduling, when FDRA of each PUSCH only overlaps with one active BWP, two alternatives may be implemented. In a first alternative of the option 1 (which may be referred to as “Option 1.1”), downlink control information (DCI) in one active BWP can schedule PUSCH in a different active BWP.

The scheduling arrangements 600 include a first scheduling arrangement 602 that illustrates the features of option 1.1. The first scheduling arrangement 602 may include a first active BWP 604 and a second active BWP 606. The first active BWP 604 and the second active BWP 606 may be part of a fragmented carrier arrangement where the first active BWP 604 and the second active BWP 606 may be separated in the frequency domain. A first DCI 608 may be transmitted in the first active BWP 604. The first DCI 608 may include information for scheduling a PUSCH 610 (such as a PUSCH transmission) in the second active BWP 606. In some embodiments, a DCI in the second active BWP 606 may schedule a PUSCH in the first active BWP 604. Further, a DCI in one of the active BWPs may be able to schedule a PUSCH in the same active BWP in option 1.1 in some embodiments.

In a second alternative of option 1 (which may be referred to a “Option 1.2”), DCI in one active BWP may schedule PUSCH in the same active BWP. The scheduling arrangements 600 include a second scheduling arrangement 612 that illustrates the features of option 1.2. The second scheduling arrangement 612 may include a first active BWP 614 and a second active BWP 616. The first active BWP 614 and the second active BWP 616 may be part of a fragmented carrier arrangement where the first active BWP 614 and the second active BWP 616 may be separated in the frequency domain. A first DCI 618 may be transmitted in the first active BWP 614. The first DCI 618 may include information for scheduling a first PUSCH 620 (such as a first PUSCH transmission) in the first active BWP 614. A second DCI 622 may be transmitted in the second active BWP 616. The second DCI 622 may include information for scheduling a second PUSCH 624 (such as a second PUSCH transmission) in the second active BWP 616. For option 1.2, a DCI in the first active BWP 614 may be unable to schedule a PUSCH in the second active BWP 616, and a DCI in the second active BWP 616 may be unable to schedule a PUSCH in the first active BWP 614.

For option 2, FDRA of each PUSCH can overlaps with more than one active BWP. The scheduling arrangements 600 include a third scheduling arrangement 626 that illustrates the features of option 2. The third scheduling arrangement 626 may include a first active BWP 628 and a second active BWP 630. The first active BWP 628 and the second active BWP 630 may be part of a fragmented carrier arrangement where the first active BWP 628 and the second active BWP 630 may be separated in the frequency domain. A first DCI 632 may be transmitted in the first active BWP 628. The first DCI 632 may include information for scheduling a first portion of a PUSCH 634 (such as a first portion of a PUSCH transmission) in the first active BWP 628 and a second portion of the PUSCH 636 (such as a second portion of the PUSCH transmission) in the second active BWP 630. In some embodiments, a DCI in one of the active BWPs may schedule a single PUSCH in the same active BWP and/or a single PUSCH in the other active BWP for option 2.

Power headroom report (PHR) approaches for two or more active BWPs are described herein. To support the simultaneous transmission in the UL for the two discontinuous frequency blocks (i.e., BWPs), the UE may use different RF architectures. In some embodiments, a UE may utilize common RF chain architecture. In some embodiments, a UE may utilize separate RF chains architecture. Depending on the RF architecture, the UE performance may be different, including how much power backoff a UE may need to meet the RF requirements, such as adjacent channel leakage ratio (ACLR) and spectrum emission mask (SEM). A new UE capability on RF architecture may be implement and separate maximum power reduction (MPR)/additional maximum power reduction (A-MPR) requirements can be specified, such as being specified in the specifications for the networks.

Accordingly, there can be two options of how PHR can be designed. In a first option (which may be referred to as “option 1”), a combined PHR can be performed for both active UL BWPs. The per UE Configured transmitted power Pc,max can be used in PHR for option 1.

In a second option (which may be referred to as “option 2”), PHR can be performed on a per BWP basis, i.e., each active UL BWP may have its own PHR and the per BWP Pc, max can be used. There may be two alternatives for option 2. In a first alternative of option 2 (which may be referred to as “option 2.1”), per BWP Pc,max can be static, such per UE Pc, max—3 decibel (dB) (or 10*logN, where N is the number of simultaneously scheduled UL BWPs). In a second alternative of option 2 (which may be referred to as “option 2.2”), per BWP Pc, max may be upper bounded by per UE Pc, max and dynamically reported by UE.

Approaches for configuring PUCCH/PUSCH/SRS with more than one active

BWP are described herein. There may be two options for PUCCH/SRS frequency domain resource allocation. In a first option (which may be referred to as “option 1”), separate resource allocation in each active BWP may be implemented. In a second option (which may be referred to as “option 2”), resource allocation can cross two active BWPs, i.e., overlap with more than one active BWPs.

There may be two options for PUCCH/PUSCH/SRS frequency hopping. In a first option (which may be referred to as “option 1”), frequency hopping may only be allowed in an active BWP. In a second option (which may be referred to as “option 2”), frequency hopping may be allowed across the two active BWPs. PUSCH/PUCCH frequency offset may be configured following the total number of PRBs of the two BWPs. SRS frequency hopping bandwidth may be configured differently for option 1 and option 2.

Channel State Information (CSI) for two or more active BWPs are described herein. A CSI configuration may be implemented for two or more active BWP operation. The CSI configuration may extend CSI-ResourceConfig to cover two active BWPs.

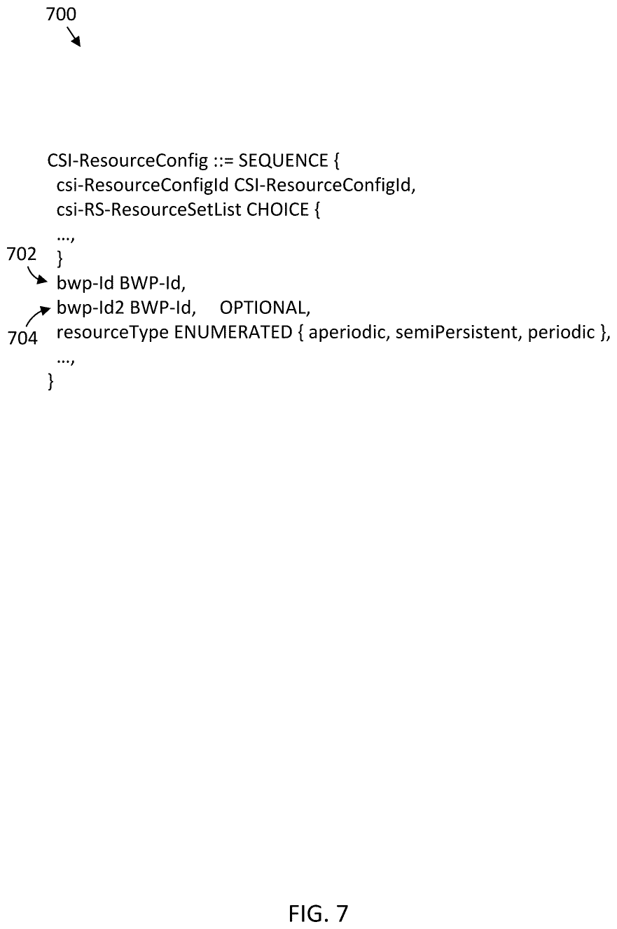

FIG. 7 illustrates a CSI resource configuration (CSI-ResourceConfig) 700 in accordance with some embodiments. The CSI-ResourceConfig 700 may be utilized for embodiments where two or more BWPs are active within a cell. The CSI-ResourceConfig 700 may include a first bandwidth part identity field 702 for configuring CSI reporting for a first active BWP and one or more additional bandwidth part identity fields for configuring CSI reporting for additional active BWPs, such as a second bandwidth part identity field 704 for configuring CSI reporting for a second active BWP.

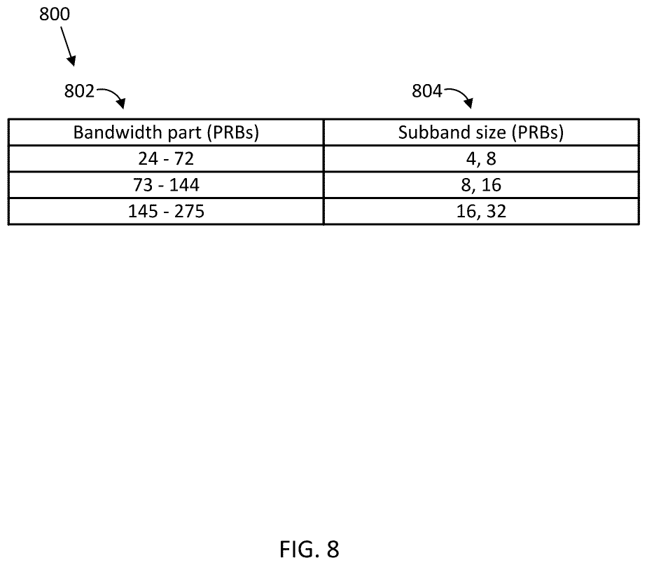

CSI reporting can be configured to be frequency selective, i.e., can contain one or multiple subband. The CSI subband size may depend on the size of BWP, i.e., number of PRBs, and/or the information element (IE) subbandSize in CSI-ReportConfig, to select the first or second value in table of FIG. 8.

FIG. 8 illustrates an example configurable subband size table 800 in accordance with some embodiments. The configurable subband size table 800 may be utilized by a network element (such as a base station) and/or a UE for determining a subband size for operation with more than one active BWP.

The configurable subband size table 800 includes bandwidth part ranges 802 and corresponding subband sizes 804. The bandwidth part ranges 802 and the corresponding subband sizes 804 may be measured in PRBs. The network element and/or the UE may determine a size of a BWP, determine which range of the bandwidth part ranges 802 in which the size of the BWP falls, and determine the configurable subband sizes for the BWP based on the corresponding subband sizes 804 to the determined bandwidth part range. For example, if the size of a BWP is between 24 and 72, the configurable subband sizes for the BWP may be determined to be 4 and 8 based on the configurable subband size table 800.

The CSI subband allocation starts from Point A (CRB, Common Resource Block, 0). For example, a point A relative to a BWP may be defined and a CSI subband allocation may be performed relative to point A. A first subband size may be given by N_{PRB}^{SB}−(N_{BWP,i}^{start}mod N_{PRB}^{SB}) and the last subband size may be given by ((N_{BWP,i}^{start}+N_{BWP,i}^{size})mod N_{PRB}^{SB} if (N_{BWP,i}^{start}+N_{BWP,i}^{size})mod N_{PRB}^{SB}≠0 and N_{PRB}^{SB} if (N_{BWP,i}^{start}+N_{BWP,i}^{size})mod N_{PRB}^{SB}=0.

The network (NW) may use bitmap (i.e., IE csi-ReportingBand in CSI-ReportConfig) to select the subband that UE should report CSI corresponding to. For example, a network element (such as a base station) may use a bitmap to select the subband for which the UE should report the CSI.

For CSI subband size, when there are more than one active BWP in a serving cell, CSI subband size can be determined based on any of the following three options. In a first option (which may be referred to as “option 1”), the CSI subband size may be determined based on the maximum size of the active BWP, i.e., max (BWP₁^{RB}, . . . , BWP_{N}^{RB}). In a second option (which may be referred to as “option 2”), the CSI subband size may be determined based on the total size of of the active BWP, i.e., BWP₁^{RB}+BWP₂^{RB}+ . . . +BWP_{N}^{RB}. In a third option (which may be referred to as “option 3”), the CSI subband size may be determined based on the total number of PRBs from the lowest PRB in the active BWP to the highest PRB in the active BWP in frequency domain. Note that BWPRB is the number of PRBs in the active BWP i.

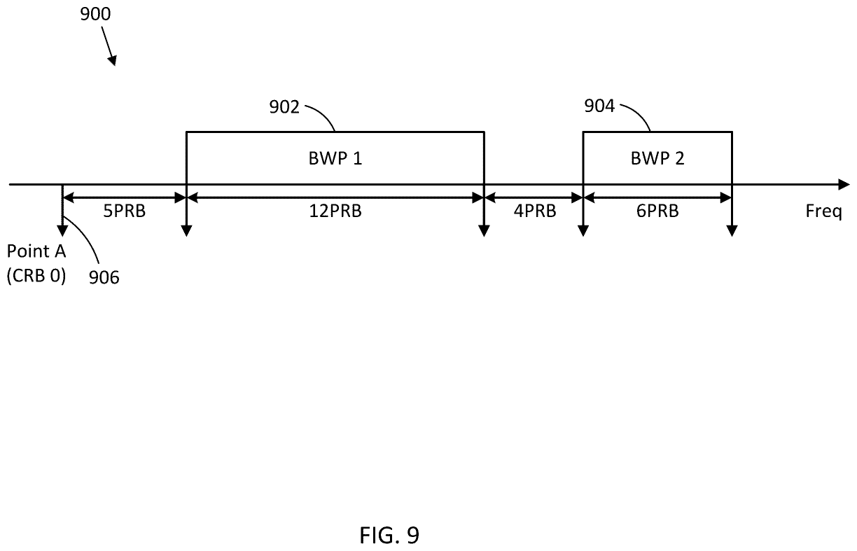

FIG. 9 illustrates an example BWP arrangement 900 in accordance with some embodiments. The BWP arrangement 900 illustrates an example implementation with two BWPs active. The BWP arrangement 900 is utilized herein for illustrating a portion of determining a CSI subband size.

The BWP arrangement 900 includes two active BWPs. The BWP arrangement 900 may include a first active BWP 902 and a second active BWP 904. Further, the BWP arrangement 900 may include a point A 906 defined as a reference for CSI subband allocation. The first active BWP 902 may be lower in frequency, and the first active BWP 902 may be 5 PRB from Point A (CRB, Common Resource Block, 0). The first active BWP 902 may contain 12 PRB. The second active BWP 904 may be higher in frequency, and the second active BWP 904 may be 4 PRB from the top of first active BWP 902. The second active BWP 904 may contain 6 PRB.

BWP size used to determine the subband size. For example, the BWP size of the first active BWP 902 and/or the second active BWP 904 may be utilized for determining the subband size in accordance with the options for determining the CSI subband size. In option 1, the CSI subband size may be determined based on max (12, 6)=12 PRB, based on the first active BWP 902 having 12 PRBs and the second active BWP 904 having 6 PRBs. In option 2, the CSI subband size may be determined based on 12+6=18 PRB, based on the first active BWP 902 having 12 PRBs and the second active BWP 904 having 6 PRBs. In option 3, the CSI subband size may be determined based on 12+6+4=22 PRB, based on the first active BWP 902 having 12 PRBs, the second active BWP 904 having 6 PRBs, and the gap between the first active BWP 902 and the second active BWP 904 including 4 PRBs.

CSI subband allocation may implement the following options. In a first option (which may be referred to as “option 1”), the CSI subband may be allocated independently for active BWP. Per active BWP, the common point A (CRB 0) may be used as reference. CSI subbands in each active BWP may be concatenated sequentially.

In a second option (which may be referred to as “option 2”), the CSI subband may be allocated jointly across all active BWP, excluding the resource blocks (RBs) between adjacent active BWP. The common point A (CRB 0) may be used as reference.

In a third option (which may be referred to as “option 3”), the CSI subband may be allocated jointly across all active BWP, including the RBs between adjacent active BWP. The common point A (CRB 0) may be used as reference. For CSI subband partially overlapping with active BWP, the size of the CSI subband may be reduced to fully overlap with active BWP. For CSI subband non-overlapping with active BWP, they may be excluded.

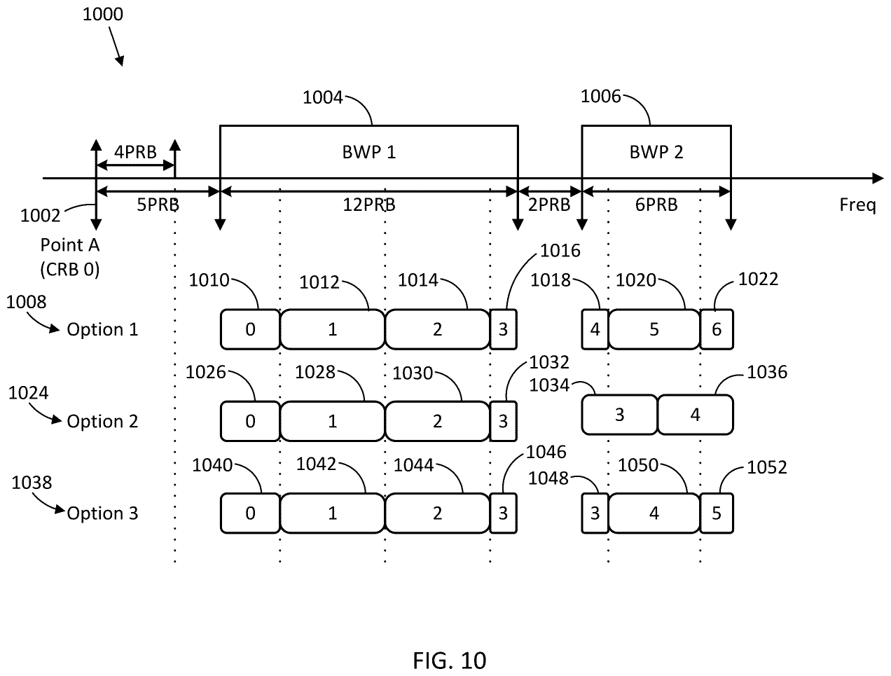

FIG. 10 illustrates an example BWP arrangement 1000 in accordance with some embodiments. The BWP arrangement 1000 illustrates the options for CSI subband allocation in accordance with the options described above.

The BWP arrangement 1000 may include a point A 1002. The point A 1002 may be defined as a reference point for CSI subband allocation.

The BWP arrangement 1000 may include two active BWPs. For example, the BWP arrangement 1000 may include a first active BWP 1004. The first active BWP 1004 may be lower in frequency. The first active BWP may start 5 PRBs from the point A 1002 (CRB, Common Resource Block, 0). The first active BWP 1004 may contain 12 PRBs.

The BWP arrangement 1000 may include a second active BWP 1006. The second active BWP 1006 may be higher in frequency. Further, the second active BWP 1006 may be 4 PRBs from the top of first active BWP 1004. The second active BWP 1006 may contain 6 PRB. The CSI subband size may be 4 PRB, which may be determined based on the first active BWP 1004 and/or the second active BWP 1006.

The BWP arrangement 1000 may include a first subband allocation arrangement 1008 in accordance with option 1 for CSI subband allocation. The first subband allocation arrangement 1008 may include 7 allocated subbands with the subbands including {3,4,4,1,1,4,1} PRBs. For example, based on the CSI subband being allocated independently for the active BWPs, the first subband allocation arrangement 1008 may include a first subband 1010, a second subband 1012, a third subband 1014, a fourth subband 1016, a fifth subband 1018, a sixth subband 1020, and a seventh subband 1022. The start of each of the subbands may be defined based on the subband size relative to the point A 1002. The first subband 1010 may include 3 PRBs based on 3 of the PRBs of the first subband 1010 being located within the first active BWP 1004. The second subband 1012 and the third subband 1014 may each include 4 PRBs based on all of the PRBs of the subbands being located within the first active BWP 1004. The fourth subband 1016 may include 1 PRB based on 1 of the PRBs of the fourth subband 1016 being within the first active BWP 1004. The fifth subband 1018 may include 1 PRB based on 1 of the PRBs of the fifth subband 1018 being within the second active BWP 1006. The sixth subband 1020 may include 4 PRBs based on all of the

PRBs of the sixth subband 1020 being located within the second active BWP 1006. The seventh subband 1022 may include 1 PRB based on 1 of the PRBs of the seventh subband 1022 being within the second active BWP 1006.

The BWP arrangement 1000 may include a second subband allocation arrangement 1024 in accordance with option 2 for CSI subband allocation. The second subband allocation arrangement 1024 may include 5 allocated subbands with the subbands including {3,4,4,4,3} PRBs. For example, based on the CSI subbands being allocated jointly across all the active BWPs (excluding the RBs between the adjacent active BWPs), the second subband allocation arrangement 1024 may include a first subband 1026, a second subband 1028, a third subband 1030, a first portion of a fourth subband 1032, a second portion of the fourth subband 1034, and a fifth subband 1036. The start of the subbands of the first active BWP 1004 may be defined based on the subband size relative to the point A 1002. As the CSI subbands are allocated jointly excluding the RBs, the subband allocation for the second active BWP 1006 may continue from the subbands defined for the first active BWP 1004. The first subband 1026 may include 3 PRBs based on 3 of the PRBs of the first subband 1026 being located within the first active BWP 1004. The second subband 1028 and the third subband 1030 may each include 4 PRBs based on all of the PRBs of the subbands being located within the first active BWP 1004. The first portion of fourth subband 1032 may include 1 PRB based on 1 PRB being available at the end of the first active BWP 1004 after the assignment of the prior subbands. As the first portion of the fourth subband 1032 includes 1 PRB, the fourth subband may have 3 PRBs to be assigned to reach the subband size of 4 PRBs after the assignment of the first portion of the fourth subband 1032. The CSI subband assignment of the fourth subband may proceed at the start of the second active BWP 1006 with the first PRBs in the second active BWP 1006 being assigned to the fourth subband to fill the subband size of 4 PRBs. Accordingly, the second portion of the fourth subband 1034 may include the first 3 PRBs of the second active BWP 1006. The fifth subband 1036 may include the remaining 3 PRBs of the second active BWP 1006 based on the fifth subband 1036 being assigned at an end of the second portion of the fourth subband 1034 and the 3 PRBs being within the second active BWP 1006.

The BWP arrangement 1000 may include a third subband allocation arrangement 1038 in accordance with option 3 for CSI subband allocation. The third subband allocation arrangement 1038 may include 6 allocated subbands with the subbands including {3,4,4,2,4, 1} PRBs. For example, based on the CSI subband being allocated jointly across all active BWPs (including the RBs between adjacent active BWPs), the third subband allocation arrangement 1038 may include a first subband 1040, a second subband 1042, a third subband 1044, a first portion of a fourth subband 1046, a second portion of the fourth subband 1048, a fifth subband 1050, and a sixth subband 1052. The start of each of the subbands may be defined based on the subband size relative to the point A 1002. The first subband 1040 may include 3 PRBs based on 3 of the PRBs of the first subband 1040 being located within the first active BWP 1004. The second subband 1042 and the third subband 1044 may each include 4 PRBs based on all of the PRBs of the subbands being located within the first active BWP 1004. The first portion of the fourth subband 1046 may include 1 PRB based on 1 of the PRBs of the first portion of the fourth subband 1046 being within the first active BWP 1004. Allocation of the fourth subband may continue including PRBs between the first active BWP 1004 and the second active BWP 1006. After the 1 PRB of the first portion of the fourth subband 1046 and the 2 PRBs within the gap between the first active BWP 1004 and the second active BWP 1006, there is still 1 PRB to be assigned to the fourth subband within the second active BWP 1006. Accordingly, the second portion of the fourth subband 1048 includes 1 PRB at a beginning of the second active BWP 1006 as the fourth PRB of the fourth subband. The fifth subband 1050 may include 4 PRBs based on all of the PRBs of the fifth subband 1050 being located within the second active BWP 1006. The sixth subband 1052 may include 1 PRB based on 1 of the PRBs of the sixth subband 1052 being within the second active BWP 1006.

In this disclosure, approaches for common restriction, scheduling and HARQ, DCI, virtual resource block (VRB) to PRB mapping and radio link monitoring for instances where more than one BWP is active within a cell are introduced.

Common restriction for instances where more than one BWP is active within a cell may include one or more of the following restrictions. When more than one active BWPs are supported in the same Serving Cell, all active BWPs may have the same numerology in order to simplify and lessen the burden on UE implementation. Numerology may include sub-carrier spacing (SCS) and/or cyclic prefix (CP) duration (CP or extended cyclic prefix (ECP)).

When more than one active BWPs are supported in the same Serving Cell, all active BWPs may be tone aligned, i.e., the distance between any sub-carrier in one active BWP and any sub-carrier in the other active BWP may be integer multiple of SCSs.

When more than one active BWPs are supported in the same Serving Cell, for PDCCH, one or multiple or all of the following restrictions may be considered for all active BWPs. A first restriction may include, at most, only one active BWP containing controlResourceSetZero. A second restriction may include, at most, only one active BWP contains searchSpaceZero/searchSpaceSIB 1/searchSpaceOtherSystemInformation/pagingSearchSpace/ra-SearchSpace. A third restriction may include a maximum total of 4 CORESETs can be configured across all the active BWP.

When more than one active BWPs are supported in the same Serving Cell, for physical downlink shared channel (PDSCH), one or multiple or all of the following restrictions may be considered for all active BWPs. A first restriction may include PDSCH time domain allocation list, i.e., PDSCH-TimeDomainResourceAllocationList is the same for all active BWP, or only one is configured. A second restriction may include consideration of the common or combined list of transmission configuration indicator (TCI) states. A third restriction may include having the same demodulation reference signal (DMRS) type, DMRS additional position, max length, scrambling identifier (ID), and/or phase tracking reference signal (PTRS) configuration. Other restrictions for the more than one active BWPs may include the same vrb-ToPRB-Interleaver size, the same resource Allocation type, the same pdsch-AggregationFactor, the same rbg-Size, the same mcs-Table, and/or the same PRB configuration type.

When more than one active BWPs are supported in the same Serving Cell, for PUCCH, one or multiple or all of the following restrictions may be considered for all active BWPs. The restrictions for consideration for all active BWPs may include the common or combined list of PUCCH resources, the common PUCCH format configuration, the same multi-CSI-PUCCH-ResourceList, the same dl-DataToUL-ACK, the common or combined list of PUCCH-SpatialRelationInfo, and/or the common or combined pucch-PowerControl.

When more than one active BWPs are supported in the same Serving Cell, for PUSCH, one or multiple or all of the following restrictions may be considered for all active BWPs. The restrictions for the more than one active BWPs may include the same PUSCH operation (i.e., codebook or nonCodebook), the same coherency type, the same maximum PUSCH rank, the same resource block group (RBG) size, enable or disable pi/2-BPSK, the same PUSCH DMRS configuration, the same PUSCH power control configuration, the PUSCH frequency hopping configuration, the same resource allocation type, the same pusch-TimeDomainAllocationList, the same pusch-AggregationFactor, the same mes-table, and/or the same waveform, DFT-s-OFDM or CP-OFDM.

Scheduling and HARQ approaches may be implemented. For PDSCH/PUSCH scheduling and HARQ operation, the following options may be implemented in terms of the PDCCH monitoring. In terms of the control resource set (CORESET) configuration, two different options may be implemented. In a first option (which may be referred to as “option 1”), each CORESET may be fully contained within one active BWP. In a second option (which may be referred to as “option 2”), a CORESET can overlap with more than one active BWP.

In terms of the PDCCH candidate, two different options may be implemented. In a first option (which may be referred to as “option 1”), each PDCCH candidate may be fully contained within one active BWP. In a second option (which may be referred to as “option 2”), a PDCCH candidate can overlap with more than one active BWP.

In terms of the PDCCH monitoring, two different options may be implemented. In a first option (which may be referred to as “option 1”), UE may only monitor PDCCH in at most one active BWP. In a second option (which may be referred to as “option 2”), UE can monitor PDCCH in more than one active BWP.

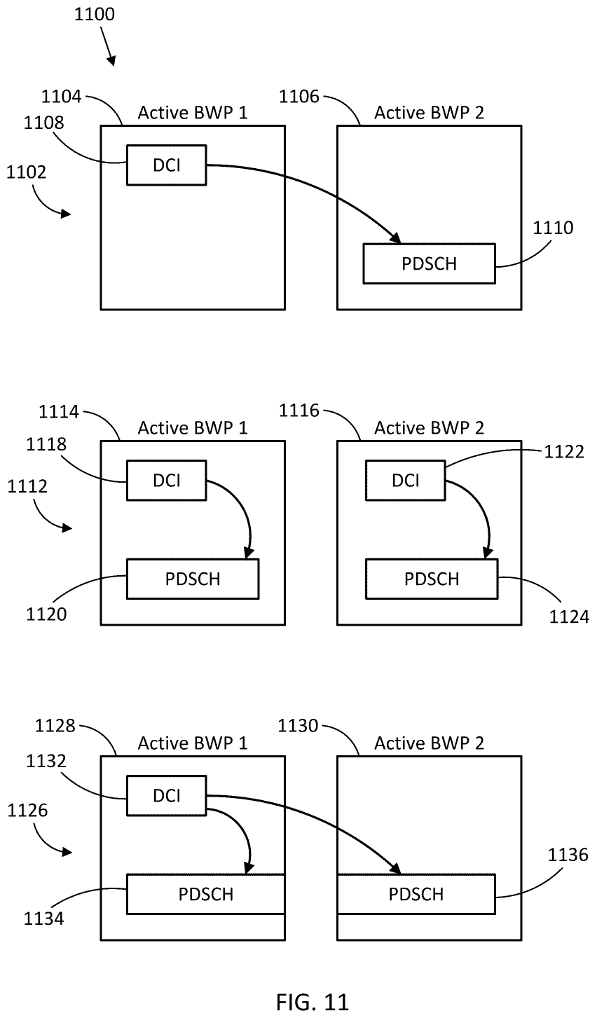

For PDSCH/PUSCH scheduling and HARQ operation, in terms of the PDSCH/PUSCH scheduling, one or more of the following PDSCH/PUSCH FDRA approaches may be implemented. For PDSCH/PUSCH FDRA, two options may be available for implementation. FIG. 11 illustrates example scheduling arrangements 1100 in accordance with some embodiments. The scheduling arrangements 1100 may illustrate features of the first option and the second option for the PDSCH/PUSCH FDRA in accordance with some embodiments.

For a first option (which may be referred to as “option 1: ), FDRA of each PDSCH/PUSCH may only overlaps with one active BWP. For scheduling, when FDRA of each PDSCH/PUSCH only overlaps with one active BWP, two alternatives of option 1 may implemented. In a first alternative of the option 1 (which may be referred to as “option 1.1”), DCI in one active BWP can schedule PDSCH/PUSCH in a different active BWP.

The scheduling arrangements 1100 include a first scheduling arrangement 1102 that illustrates the features of option 1.1. The first scheduling arrangement 1102 may include a first active BWP 1104 and a second active BWP 1106. The first active BWP 1104 and the second active BWP 1106 may be part of a fragmented carrier arrangement where the first active BWP 1104 and the second active BWP 1106 may be separated in the frequency domain. A first DCI 1108 may be transmitted in the first active BWP 1104. The first DCI 1108 may include information for scheduling a PDSCH 1110 (such as a PDSCH transmission) in the second active BWP 1106. In some embodiments, a DCI in the second active BWP 1106 may schedule a PDSCH in the first active BWP 1104. Further, a DCI in one of the active BWPs may be able to schedule a PDSCH in the same active BWP in option 1.1 in some embodiments.

In a second alternative of the option 1 (which may be referred to as “option 1.2”), DCI in one active BWP may schedule PDSCH/PUSCH in the same active BWP. In option 1.2, a DCI in one active BWP may be unable to schedule PDSCH/PUSCH in a different active BWP. The scheduling arrangements 1100 include a second scheduling arrangement 1112 that illustrates the features of option 1.2. The second scheduling arrangement 1112 may include a first active BWP 1114 and a second active BWP 1116. The first active BWP 1114 and the second active BWP 1116 may be part of a fragmented carrier arrangement where the first active BWP 1114 and the second active BWP 1116 may be separated in the frequency domain. A first DCI 1118 may be transmitted in the first active BWP 1114. The first DCI 1118 may include information for scheduling a first PDSCH 1120 (such as a first PDSCH transmission) in the first active BWP 1114. A second DCI 1122 may be transmitted in the second active BWP 1116. The second DCI 1122 may include information for scheduling a second PDSCH 1124 (such as a second PDSCH transmission) in the second active BWP 1116. For option 1.2, a DCI in the first active BWP 1114 may be unable to schedule a PDSCH in the second active BWP 1116, and a DCI in the second active BWP 1116 may be unable to schedule a PDSCH in the first active BWP 1114.

For a second option (which may be referred to as “option 2”), FDRA of each PDSCH/PUSCH can overlap with more than active BWP. The scheduling arrangements 1100 include a third scheduling arrangement 1126 that illustrates the features of option 2. The third scheduling arrangement 1126 may include a first active BWP 1128 and a second active BWP 1130. The first active BWP 1128 and the second active BWP 1130 may be part of a fragmented carrier arrangement where the first active BWP 1128 and the second active BWP 1130 may be separated in the frequency domain. A first DCI 1132 may be transmitted in the first active BWP 1128. The first DCI 1132 may include information for scheduling a first portion of a PDSCH 1134 (such as a first portion of a PDSCH transmission) in the first active BWP 1128 and a second portion of the PDSCH 1136 (such as a second portion of the PDSCH transmission) in the second active BWP 1130. In some embodiments, a DCI in one of the active BWPs may schedule a single PDSCH in the same active BWP and/or a single PDSCH in the other active BWP for option 2.

For PDSCH/PUSCH scheduling and HARQ operation, the following options may be implemented in terms of the HARQ operation. In terms of the HARQ process pool, two different options may be implemented. In a first option (which may be referred to as “option 1”), all active BWPs in the same serving cell may share one HARQ process pool, each HARQ process may have different HARQ process ID.

In a second option (which may be referred to as “option 2”), each active BWPs in the same serving cell may have an independent HARQ process pool, and/or different HARQ processes in the same active BWP may have different HARQ process IDs, but different HARQ processes in different active BWP may have the same HARQ process ID.

In terms of the maximum number of HARQ process, two different options may be implemented. In a first option (which may be referred to as “option 1”), there may be a maximum number of HARQ processes of 16 across all the active BWPs in the same serving cell. In a second option (which may be referred to as “option 2”), that may be a maximum number of HARQ processes of 16 for each active BWPs in the same serving cell.

In terms of the HARQ retransmission, when FDRA of each PDSCH/PUSCH only overlaps with one active BWP, two different options may be implemented. In a first option (which may be referred to as “option 1”), HARQ retransmission can be scheduled in a different active BWP in the same serving cell. In a second option (which may be referred to as “option 2”), HARQ retransmission may be scheduled in the same active BWP in the same serving cell.

DCI enhancement may be implemented. For FDRA, two options may be implemented. In a first option (which may be referred to as “option 1”), the bitwidth and encoding of the FDRA may only consider the union of the active BWPs. In a second option (which may be referred to as “option 2”), the bitwidth and encoding of the FDRA may consider also the frequency between active BWPs, i.e., the lowest frequency of the lowest active BWP to the highest frequency of the highest BWP.

Different approaches may be utilized for bandwidth part indicators for instances where more than one active BWP is implemented within a cell. With two active BWPs, the DCI may indicate the following BWP switch cases of one active BWP to two active BWPs, two active BWPs to one active BWP, and/or two active BWPs to two active BWPs.

For a first option (which may be referred to as “option 1”) of BWP indicators, another indicator field may be added to indicate the second BWP. For a second option (which may be referred to as “option 2”) of BWP indicators, a four-bit bitmap may be utilized, with the first bit set to “1” indicating the first BWP, the second bit set to “1” the second BWP, and so on. The bitmap value of 1010 indicates BWP ID 1 and 3 are activated. In particular, the options may be utilized to indicate which BWPs are to be active within a cell.

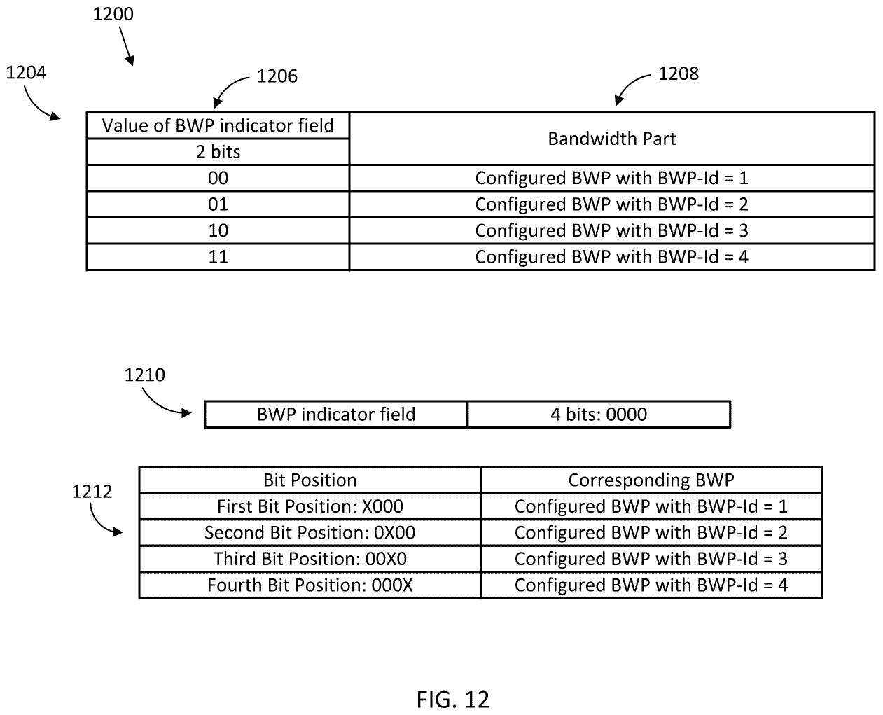

FIG. 12 illustrates example BWP indicator arrangements 1200 in accordance with some embodiments. In particular, the BWP indicator arrangements 1200 indicate bit arrangements that may be utilized for indicating which BWPs are to be active in a cell.

The BWP indicator arrangements 1200 include a first table 1202. The first table 1202 illustrates example bit arrangements that may be utilized for indicating BWPs to be active in accordance with option 1. The first table 1202 includes BWP indicator field values 1204. The BWP indicator field values 1204 may be values included in a single BWP indicator field, where a number of BWP indicator fields in an implementation may be equal to a number of BWPs to be active in a cell in the implementation. The BWP indicator field values 1204 may include two bits.

The first table 1202 further includes BWP indications 1206. The BWP indications 1206 indicate a BWP to which the corresponding indicator field value of the BWP indicator field values 1204 may refer. For example, the BWP value of 00 may correspond to the configured BWP with a BWP-ID of 1. The BWP value of 01 may correspond to the configured BWP with a BWP-ID of 2. The BWP value of 10 may correspond to the configured BWP with a BWP-ID of 3. The BWP value of 11 may correspond to the configured BWP with a BWP-ID of 4.

The BWP indicator arrangements 1200 include a BWP indicator field example 1210 and a corresponding BWP table 1212. The BWP indicator field example 1210 illustrates an example of a BWP indicator field that can be utilized for indicating BWPs to be active in a cell. The BWP indicator field example 1210 may include a number of bits equal to a number of configured BWPs that can be made active, which is 4 bits in the illustrated embodiment. Each of the bit positions of the BWP indicator field example 1210 may correspond to a configured BWP, as illustrated by the corresponding BWP table 1212. A bit position with a value of 1 may indicate that the corresponding configured BWP is to be active, and a bit position with a value of 0 may indicate that the corresponding configured BWP is to be inactive. In the illustrated embodiment, the first bit position may correspond to a configured BWP with BWP-ID of 1. The second bit position may correspond to a configured BWP with BWP-ID of 2. The third bit position may correspond to a configured BWP with BWP-ID of 3. The fourth bit position may correspond to a configured BWP with BWP-ID of 4.

VRB to PRB mapping approaches for cells with more than one active BWP are described herein. Mapping from VRB to PRB for PDSCH may be implemented for cells with more than one active BWP. In legacy approaches, PRBs are defined within a BWP and numbered from 0 to BWP_size−1. VRB to PRB mapping is done within a BWP.

When two BWPs are active, approaches for VRB to PRB mapping may be based on the interleaved cases or the non-interleaved cases. For interleaved cases, two options may be available for implementation of VRB to PRB mapping for cells with more than one active BWP.

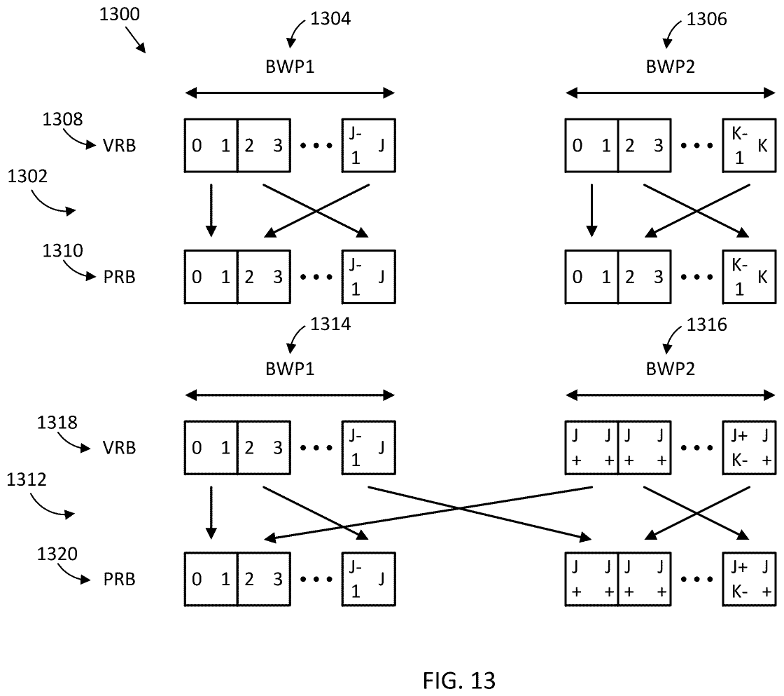

FIG. 13 illustrates example VRB to PRB mappings 1300 for interleaved cases in accordance with some embodiments. For example, the VRB to PRB mappings 1300 illustrate example mappings that may be implemented in accordance with the two options for VRB to PRB mappings.

In a first option (which may be referred to as “option 1”) for VRB to PRB mappings, when each BWP has its own PDSCH, the VRB to PRB mapping can be done within the respective BWP. The VRB to PRB mappings 1300 include a first interleaved mapping 1302. The first interleaved mapping 1302 illustrates an example mapping that may be implemented in accordance with the first option. In the illustrated embodiment, the first interleaved mapping 1302 includes a first active BWP 1304 and a second active BWP 1306. The first interleaved mapping 1302 further includes VRBs 1308 and PRBs 1310, where arrows between the VRBs 1308 and the PRBs 1310 indicate the mappings between the VRBs 1308 and the PRBs 1310. For the first interleaved mapping 1302, the mappings of the VRBs 1308 in the first active BWP 1304 are to PRBs 1310 in the first active BWP 1304, and the mappings of the VRBs 1308 in the second active BWP 1306 are to PRBs 1310 in the second active BWP 1306. The mappings may be interleaved (e.g., the VRBs of 2 and 3 are mapped to the PRBs of J−1 and J, respectively).

In a second option (which may be referred to as “option 2”) for VRB to PRB mappings, when there is only one PDSCH across both BWPs, the PRBs of two BWPs are concatenated, forming an aggregated PRB set. In a first alternative of the second option (which may be referred to as “Alt. 1”), the size of RB bundles can still be 2 or 4 RBs, since the total number of aggregated PRBs is still smaller than that of a single CC. In a second alternative of the second option (which may be referred to as “Alt. 2”), the size of RB bundles can be set to a value greater than 4 RBs in case the total number of aggregated PRBs is greater than that of a single CC.

The VRB to PRB mappings 1300 include a second interleaved mapping 1312. The second interleaved mapping 1312 illustrates an example mapping that may be implemented in accordance with the second option. In the illustrated embodiment, the second interleaved mapping 1312 includes a first active BWP 1314 and a second active BWP 1316. The second interleaved mapping 1312 further includes VRBs 1318 and PRBs 1320, where arrows between the VRBs 1318 and the PRBs 1320 indicate the mappings between the VRBs 1318 and the PRBs 1320. For the second interleaved mapping 1312, a portion of the mappings of the VRBs 1318 in the first active BWP 1314 may be to PRBs 1320 in the second active BWP 1316, and a portion of the mappings of the VRBs 1318 in the second active BWP 1316 may be to PRBs 1320 in the first active BWP 1314. The mappings may be interleaved (e.g., the VRBs of 2 and 3 are mapped to the PRBs of J−1 and J, respectively).

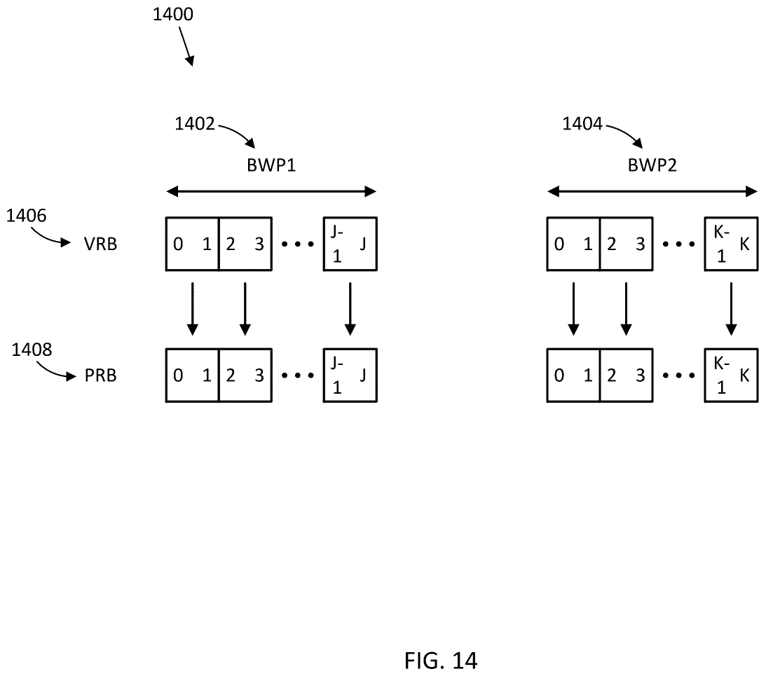

For non-interleaved cases, the implementations may be similar to the interleaved case, except that VRBs may be directly mapped to PRBs without any interleaving. FIG. 14 illustrates an example non-interleaved mapping 1400 in accordance with some embodiments. The non-interleaved mapping 1400 illustrates an example mapping that may be implemented for non-interleaved cases. In the illustrated embodiment, the non-interleaved mapping 1400 includes a first active BWP 1402 and a second active BWP 1404. The non-interleaved mapping 1400 further includes VRBs 1406 and PRBs 1408, where arrows between the VRBs 1406 and the PRBs 1408 indicate the mappings between the VRBs 1406 and the PRBs 1408. For the non-interleaved mapping 1400, the mappings may be non-interleaved (e.g., the VRBs of 0 and 1 are mapped to the PRBs of 0 and 1, and so forth).

Radio link monitoring approaches for a cell with more than one active BWP. The network can configure radio link monitoring reference signal (RS) in each active BWP. The UE may indicate radio link failure in accordance with two options. In a first option (which may be referred to as “option 1”), the UE may indicate radio link failure only when the radio link quality is worse than the threshold Qout for all resources in the set of resources for radio link monitoring, i.e., for both BWPs. In a second option (which may be referred to as “option 2”), the UE may indicate radio link failure when the radio link quality is worse than the threshold Qout for all resources in the set of resources for radio link monitoring in the BWP where synchronization signal block (SSB) is transmitted, if SSBs are not transmitted in both BWPs.

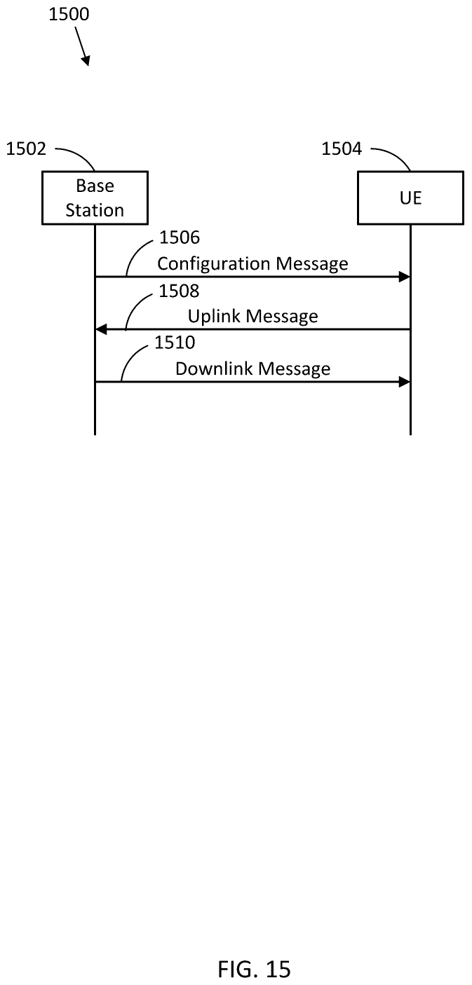

FIG. 15 illustrates an example signaling chart 1500 in accordance with some embodiments. The signaling chart 1500 illustrates signaling that, at least some portion thereof, that may be utilized for implementing, or may be implemented, for one or more of the approaches described herein.

The signaling chart 1500 includes a base station 1502. The base station 1502 may include one or more of the features of the base station 108 (FIG. 1) and/or the network device 300 (FIG. 3). The signaling chart 1500 includes a UE 1504. The UE 1504 may include one or more of the features of the UE 104 (FIG. 1), the UE 106 (FIG. 1), and/or the UE 200 (FIG. 2). The UE 1504 may be in a cell hosted by the base station 1502, where the cell supports more than one active BWP at a time.

The base station 1502 may generate and/or transmit a configuration message 1506 to the UE 1504. The configuration message 1506 may include configuration information that can configure the UE 1504 in accordance with one or more of the approaches described herein. The configuration message 1506 may configure the UE 1504 for one or more uplink messages and/or one or more downlink messages. The UE 1504 may be configured for utilizing more than one active BWP by the configuration message 1506.

In some embodiments, the UE 1504 may generate and/or transmit a UL message 1508 for transmission to the base station 1502. The UL message 1508 may have been configured by the configuration message 1506. The UL message 1508 may be any of the UL messages (including reports) that can be configured in the approaches described herein. In some embodiments, the UL message 1508 may be omitted.

In some embodiments, the base station 1502 may generate and/or transmit a DL message 1510 for transmission to the UE 1504. The DL message 1510 may have been configured by the configuration message 1506. The DL message 1510 may be any of the DL messages that can be configured in the approaches described herein. In some embodiments, the DL message 1510 may be omitted.

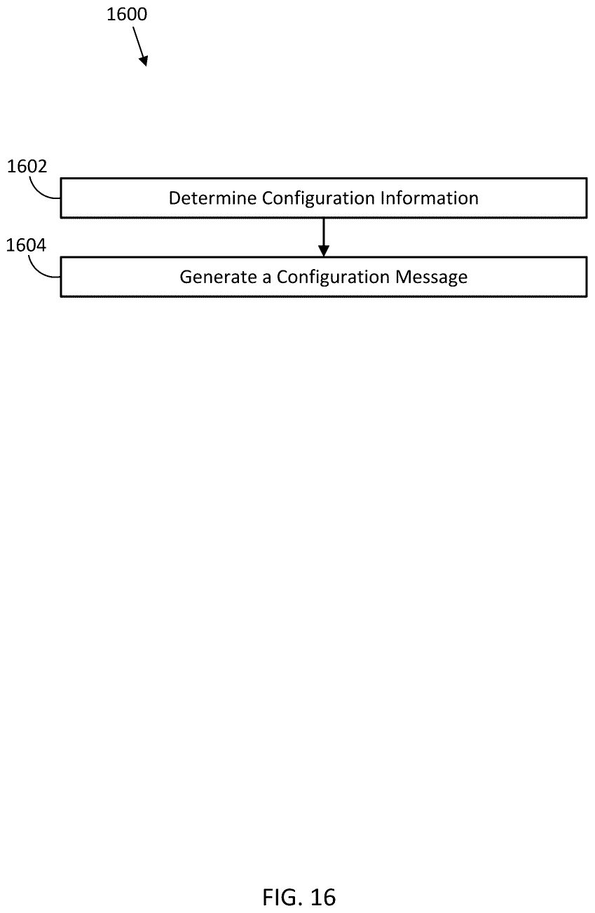

FIG. 16 illustrates an example procedure 1600 for configuring operation of two or more BWPs in a cell in accordance with some embodiments. The procedure 1600 may be performed by a base station, such as the base station 108 (FIG. 1), the network device 300 (FIG. 3), and/or the base station 1502 (FIG. 15).

The procedure 1600 may include determining configuration information in 1602. For example, the base station may determine configuration information for fragmented carriers with two or more active BWPs within a serving cell.

In some embodiments, the two or more active BWPs may share one HARQ process pool. Each HARQ process for the two or more active BWPs may have different HARQ process IDs.

In some embodiments, each active BWP of the two or more active BWPs may have an independent HARQ process pool. The HARQ processes within a same active BWP may have different HARQ process IDs. The different HARQ processes in different active BWPs may have the same HARQ process ID.

In some embodiments, a maximum number of HARQ processes may be sixteen across the two or more active BWPs. Further, a maximum number of HARQ processes may be sixteen for each BWP within the two or more active BWPs in some embodiments.

In some embodiments, HARQ retransmission for an HARQ transmission within the two or more active BWPs can be scheduled in a different active BWP than a BWP for the HARQ transmission. Further, HARQ retransmission for an HARQ transmission with the two or more active BWPs may be scheduled within a same active BWP as the HARQ transmission.

In some embodiments, a bitwidth and encoding of an FDRA for the two or more active BWPs may consider a union of the two or more active BWPs. Further, a bitwidth and encoding of a FDRA for the two or more active BWPs may consider the two or more active BWPs and frequency between the two or more active BWPs.

In some embodiments, each BWP of the two or more BWPs may have an own PDSCH, and a VRB to PRB mapping may be generated for each BWP.

In some embodiments, the two or more BWPs may have one PDSCH, and physical resource blocks of the two or more BWPs may be concatenated. In some of these embodiments, a size of RB bundles for the two or more BWPs may be two RBs or four RBs. In some of these embodiments, a size of RB bundles for the two or more BWPs is greater than four RBs.

In some embodiments, the VRB to PRB mapping may include interleaving. Further, the VRB to PRB mapping may be non-interleaved in some embodiments.

In some embodiments, FDRA of each PUSCH for the two or more active BWPs may overlap with only one active BWP. The FDRA of each PUSCH for the two or more active BWPs may overlap with more than one active BWP in some embodiments.

In some embodiments, a combined PHR procedure may be performed for the two or more BWPs. A per UE configured transmitted power Pc, max may be utilized for the PHR. In some embodiments, power headroom reporting may be performed on a per BWP basis. In some of these embodiments, a per BWP Pc,max value may be static. In some of these embodiments, a per BWP Pc, max value may be upper bounded by a per UE Pc, max value.

In some embodiments, each active BWP of the two or more active BWPs may have separate PUSCH/SRS frequency domain resource allocation. In some embodiments, PUSCH/SRS frequency domain resource allocation for the two or more active BWPs can cross two cross two active BWPs of the two or more active BWPs.

In some embodiments, frequency hopping may be allowed only in an active BWP of the two or more active BWPs. Further, frequency hopping may be allowed across two active BWPs of the two or more active BWPs in some embodiments.

In some embodiments, a CSI subband size may be determined based at least in part on a maximum BWP size of the two or more active BWPs. A CSI subband size may be determined based at least in part on a total size of the two or more active BWPs in some embodiments. In some embodiments, a CSI subband size may be determined based at least in part on a total number of PRBs from a lowest PRB in the two or more active BWPs to a highest PRB in the two or more active BWPs in a frequency domain.

In some embodiments, a CSI subband allocation may be allocated independently for each active BWP of the two or more active BWPs. A CSI subband allocation may be allocated jointly across the two or more active BWPs excluding resource blocks between adjacent BWPs of the two or more active BWPs in some embodiments. In some embodiments, a CSI subband allocation is allocated jointly across the two or more active BWPs including resource blocks between adjacent BWPs of the two or more active BWPs.

In some embodiments, two or more active BWPs may have a same numerology, or may be tone aligned. In some embodiments, only one active BWP of the two or more BWPs may contain controlResourceSetZero, or only one active BWP of the two or more BWPs may contain searchSpaceZero/searchSpaceSIB 1/searchSpaceOtherSystemInformation/pagingSearchSpace/ra-SearchSpace. In some embodiments, a maximum of four CORESETs can be configured across the two or more active BWPs.

In some embodiments, PDSCH-TimeDomainResourceAllocationList may be same for the two or more active BWPs or configured for only one active BWP of the two or more active BWPs, the two or more active BWPs may have a common or combined list of transmission configuration indicator (TCI) states, the two or more active BWPs may have a same demodulation reference signal (DMRS) type, a same DMRS additional position, a same max length, a same scrambling identifier (ID), or a same phase tracing reference signal (PTRS), the two or more active BWPs may have a same vrb-ToPRB-Interleaver size, the two or more active BWPs may have a same resourceAllocation type, the two or more active BWPs may have a same pdsch-AggregationFactor, the two or more active BWPs may have a same rgb-Size, the two or more active BWPs may have a same mes-Table, or the two or more active BWPs may have a same physical resource block (PRB) configuration type.

In some embodiments, the two or more active BWPs may have a common or

combined list of physical uplink control channel (PUCCH) resources, a common PUCCH format configuration, a same multi-CSI-PUCCH-ResourceList, a same dl-DataToUL-ACK, a common or combined list of PUCCH-SpatialRelationInfo, a common or combined pucch-PowerControl, a same PUSCH operation, a same coherency type, a same maximum physical uplink shared channel (PUSCH) rank, a same resource block group (RBG) size, enabled or disabled pi/2-BPSK, a same physical uplink shared channel (PUSCH) demodulation reference signal (DMRS) configuration, a same PUSCH frequency hopping configuration, a same resource allocation type, a same pusch-TimeDomainAllocationList, a same pusch-AggregationFactor, a same mcs-table, or a same waveform.

The procedure 1600 may include generating a configuration message in 1604. For example, the base station may generate a configuration message for transmission to a UE. The configuration message may include the configuration information.

In some embodiments, the configuration message may be to configure a CORESET to be contained within one active BWP. The configuration message may be to configure a CORESET to overlap with more than one active BWP in some embodiments.

In some embodiments, the configuration message may be to configure each PDCCH candidate to be contained within one active BWP. The configuration may be to configure a PDCCH candidate to overlap with more than one active BWP in some embodiments.

In some embodiments, the configuration message may be to configure the UE to monitor at most one active BWP for a PDCCH. The configuration message may be to configure the UE to monitor more than one active BWP for a PDCCH in some embodiments.

In some embodiments, the configuration message may be to configure an FDRA of each PDSCH/PUSCH to overlap with only one active BWP. The configuration message may be to configure an FDRA of each PDSCH/PUSCH to overlap with more than one active BWP for the FDRA in some embodiments.

In some embodiments, the configuration message may include DCI to schedule PDSCH/PUSCH in another active BWP, where the configuration message may be transmitted in one active BWP. The configuration message may include DCI to schedule PDSCH/PUSCH in one active BWP, where the configuration message may be transmitted in the one active BWP in some embodiments.

In some embodiments, the configuration message may include a number of active BWP indicator fields equal to a number of the two or more active BWPS. Each BWP indicator field of the BWP indicator fields may indicate a BWP to be active.

In some embodiments, the configuration message may include an active BWP indicator field of four bits. Each bit of the active BWP indicator field indicates a corresponding BWP to be active.

In some embodiments, the configuration message may include an indication to transition to the one BWP being active or the more than one BWP being active.

In some embodiments, the configuration message may be to configure radio link failure to be indicated when all resources in a set of resources for radio link monitoring for the two or more active BWPs is worse than a threshold Qout. In some embodiments, the configuration message may be to configure radio link failure to be indicated when all resources in the set of resources for radio link monitoring for the BWP is worse than a threshold Qout.

In some embodiments, the configuration message may be transmitted in a first BWP of the two or more active BWPs. The configuration message may include DCI that schedules PUSCH in a second BWP of the two or more active BWPs.

In some embodiments, the configuration message may be transmitted in a BWP of the two or more active BWPs. The configuration message may include DCI that schedules PUSCH in the BWP of the two or more active BWPs.

In some embodiments, the configuration message may be to configure the UE to dynamically report one or more PHRs.

In some embodiments, the configuration message may include a CSI configuration IE. The CSI configuration IE may include a first field that indicates a first CSI is to be provided for a first BWP of the two or more BWPs, and a second field that indicates a second CSI is to be provided for a second BWP of the two or more BWPs.

Any one or more of the operations in FIG. 16 may be performed in a different order than shown and/or one or more of the operations may be performed concurrently in embodiments. Further, it should be understood that one or more of the operations may be omitted from and/or one or more additional operations may be added to the procedure 1600 in other embodiments.

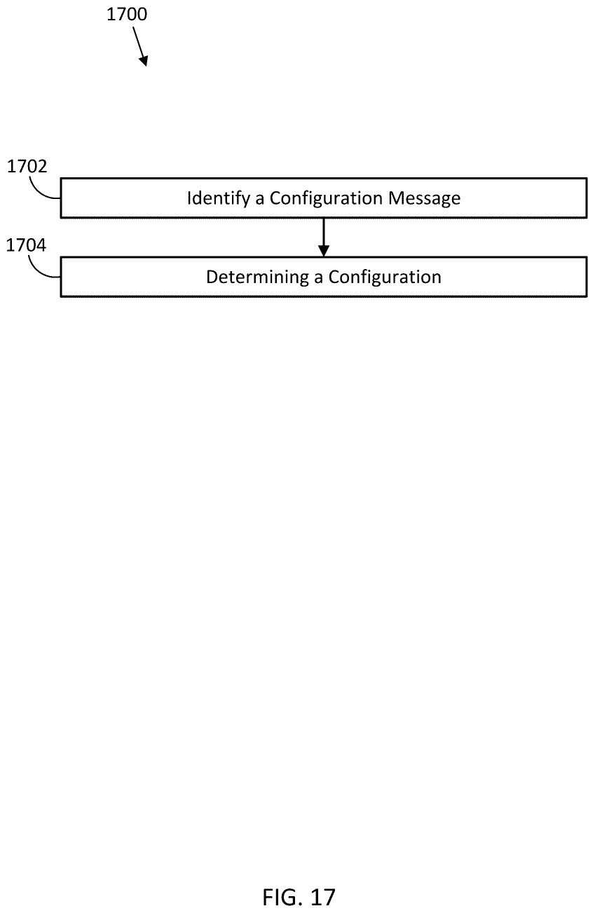

FIG. 17 illustrates an example procedure 1700 for determining a configuration for two or more active BWPs in a cell in accordance with some embodiments. The procedure 1700 may be performed by a UE, such as the UE 104 (FIG. 1), the UE 106 (FIG. 1), the UE 200 (FIG. 2), and/or the UE 1504 (FIG. 15).

The procedure 1700 may include identifying a configuration message in 1702. For example, the UE may identify a configuration message for fragmented carriers with two or more active BWPs within a serving cell.

In some embodiments, the configuration message may indicate a CORESET is included within one active BWP of the two or more BWPs. The configuration message may indicate a CORESET overlaps with the more than one active BWP in some embodiments.

In some embodiments, the configuration message may indicate each PDCCH candidate for the two or more active BWPs is contained within one active BWP. The configuration message may indicate that a PDCCH candidate overlaps with more than one active BWP of the two or more BWPs.

In some embodiments, the configuration message may indicate one active BWP of the two or more active BWPs to monitor for a PDCCH. In some embodiments, the configuration message may indicate more than one active BWP of the two or more active BWPs to monitor for a PDCCH.

In some embodiments, the configuration message may indicate one active BWP for FDRA of a PDSCH/PUSCH. The configuration message may indicate more than one active BWP for FDRA of a PDSCH/PUSCH.

In some embodiments, the configuration message may include DCI for scheduling a PDSCH/PUSCH transmission, where the configuration message may be received in a first active BWP of the two or more active BWPs. In some embodiments, the configuration message may include DCI for scheduling a PDSCH/PUSCH transmission, where the configuration message may be received in an active BWP of the two or more active BWPs.

In some embodiments, the configuration message may include a number of active BWP indicator fields equal to a number of the two or more active BWPs, where each BWP indicator field of the BWP indicators fields indicates a BWP to be active. In some embodiments, the configuration message may include an active BWP indicator field of four bits, where each bit of the active BWP indicator field indicates a corresponding BWP to be active.

In some embodiments, the configuration message may include an indication of a transmission to one BWP being active or more than one BWP being active.

In some embodiments, the configuration message may include an indication that radio link failure is to be indicated when all resources in a set of resources for radio link monitoring for the two or more active BWPs is worse than a threshold Qout. In some embodiments, the configuration message may include an indication that radio link failure is to be indicated when all resources in a set of resources for radio link monitoring for a BWP is worse than a threshold Qout.

In some embodiments, the configuration message may be received in a first BWP of the two or more active BWPs, where the configuration message may include DCI that schedules PUSCH in a second BWP BWP of the two or more active BWPs. In some embodiments, the configuration message may be received in a BWP of the two or more active BWPs, where the configuration message may include DCI that schedules PUSCH in the BWP of the two or more active BWPs.

In some embodiments, the configuration message may indicate that one or more PHRs are to be dynamically reported.

In some embodiments, the configuration message may include a CSI configuration IE, where the CSI configuration IE may include a first field that indicates a first CSI is to be provided for a first BWP of the two or more BWPs and a second field that indicates a second CSI is to be provided for a second BWP of the two or more BWPs.

In some embodiments, the two or more active BWPs may share one hybrid HARQ process pool, where each HARQ process for the two or more active BWPs have different HARQ process IDs. In some embodiments, each active BWP of the two or more active BWPs may have an independent HARQ process pool, where HARQ processes within a same active BWP may have different HARQ process IDs, and where different HARQ processes in different active BWPs have the same HARQ process ID.

In some embodiments, a maximum number of HARQ processes may be sixteen across the two or more active BWPs. Further, a maximum number of HARQ processes may be sixteen for each BWP within the two or more active BWPs in some embodiments.

In some embodiments, HARQ retransmission for an HARQ transmission with two or more active BWPs may be scheduled in a different active BWP than a BWP for the HARQ transmission. In some embodiments, HARQ retransmission for an HARQ transmission with the two or more active BWPs may be scheduled within a same active BWP as the HARQ transmission.

In some embodiments, a bitwidth and encoding of an FDRA for the two or more active BWPs may consider a union of the two or more active BWPs. In some embodiments, a bitwidth and encoding of an FDRA for the two or more active BWPs may consider the two or more active BWPs and frequency between the two or more active BWPs.

In some embodiments, each BWP of the two or more BWPs may have an own PDSCH, where a VRB to PRB mapping is generated for each BWP. In some embodiments, the two or more BWPs may have one PDSCH, where physical resource blocks of the two or more BWPs are concatenated. In some of these embodiments, a size of RB bundles for the two or more BWPs may be two RBs or four RBs. In some embodiments, a size of RB bundles for the two or more BWPs may be greater than four RBs. In some embodiments, the VRB to PRB mapping may include interleaving. In some embodiments, the VRB to PRB mapping may be non-interleaved.

In some embodiments, FDRA of each PUSCH for the two or more active BWPs may overlap with only one active BWP. In some embodiments, FDRA of each PUSCH for the two or more active BWPs may overlap with more than one active BWP.

In some embodiments, a combined PHR procedure may be performed for the two or more active BWPs, were a per UE configured transmitted power Pc,max is to be utilized for the PHR. In some embodiments, power headroom reporting may be performed on a per BWP basis. In some of these embodiments, a per BWP Pc,max value may be static. In some of these embodiments, a per BWP Pc,max may be upper bounded by a per UE Pc, max value.

In some embodiments, each active BWP of the two or more active BWPs may have separate PUSCH/SRS frequency domain resource allocation. In some embodiments, PUSCH/SRS frequency domain resource allocation for the two or more active BWPs can cross two active BWPs of the two or more active BWPs.

In some embodiments, frequency hopping may be allowed only in an active BWP of the two or more active BWPs. In some embodiments, frequency hopping may be allowed across two active BWPs of the two or more active BWPs.

In some embodiments, a CSI subband size may be determined based at least in part on a maximum BWP size of the two or more active BWPs. A CSI subband size may be determined based at least in part on a total size of the two or more active BWPs in some embodiments. In some embodiments, a CSI subband size may be determined based at least in part on a total number of PRBs from a lowest PRB in the two or more BWPs to a highest PRB in the two or more active BWPs in a frequency domain.

In some embodiments, a CSI subband allocation may be allocated independently for each active BWP of the two or more active BWPs. A CSI subband allocation may be allocated jointly across the two or more active BWPs excluding resource blocks between adjacent BWPs of the two or more active BWPs in some embodiments. In some embodiments, a CSI subband allocation may be allocated jointly across the two or more active BWPs including resource blocks between adjacent BWPs of the two or more active BWPs.

In some embodiments, the two or more active BWPs may have a same numerology, or may be tone aligned. In some embodiments, only one active BWP may contain controlResourceSetZero, or only one active BWP may contain searchSpaceZero/searchSpaceSIB1/searchSpaceOtherSystemInformation/pagingSearchSpace/ra-SearchSpace. In some embodiments, a maximum of four CORESETs can be configured across the two or more active BWPs.

In some embodiments, PDSCH-TimeDomainResourceAllocationList may be the same for the two or more active BWPs or may be configured for only one active BWP of the two or more active BWPs, the two or more active BWPs may have a common or combined list of transmission configuration indicator (TCI) states, the two or more active BWPs may have a same demodulation reference signal (DMRS) type, a same DMRS additional position, a same max length, a same scrambling identifier (ID), or a same phase tracing reference signal (PTRS), the two or more active BWPs may have a same vrb-ToPRB-Interleaver size, the two or more active BWPs may have a same resourceAllocation type, the two or more active BWPs may have a same pdsch-AggregationFactor, the two or more active BWPs may have a same rgb-Size, the two or more active BWPs may have a same mes-Table, or the two or more active BWPs may have a same physical resource block (PRB) configuration type.

In some embodiments, the two or more active BWPs may have a common or combined list of physical uplink control channel (PUCCH) resources, a common PUCCH format configuration, a same multi-CSI-PUCCH-ResourceList, a same dl-DataToUL-ACK, a common or combined list of PUCCH-SpatialRelationInfo, a common or combined pucch-PowerControl, a same PUSCH operation, a same coherency type, a same maximum physical uplink shared channel (PUSCH) rank, a same resource block group (RBG) size, enabled or disabled pi/2-BPSK, a same physical uplink shared channel (PUSCH) demodulation reference signal (DMRS) configuration, a same PUSCH frequency hopping configuration, a same resource allocation type, a same pusch-TimeDomainAllocationList, a same pusch-AggregationFactor, a same mcs-table, or a same waveform.

The procedure 1700 may include determining a configuration in 1704. For example, the UE may determine a configuration for the two or more active BWPs based at least in part on the configuration message.

In some embodiments, determining the configuration may include determining to monitor the one active BWP for the CORESET. In some embodiments, determining the configuration may include determining to monitor the more than one active BWP for the CORESET.

In some embodiments, determining the configuration may include determining to monitor the one active BWP for the PDCCH. In some embodiments, determining the configuration may include determining to monitor the more than one active BWP for the PDCCH.

In some embodiments, determining the configuration may include determining to monitor the one active BWP for the FDRA. In some embodiments, determining the configuration may include determining to monitor the more than one active BWP for the FDRA.

In some embodiments, determining the configuration may include determining the PDSCH/PUSCH transmission is scheduled in a second active BWP of the two or more active BWPs based at least in part on the DCI. In some embodiments, determining the configuration may include determining the PDSCH/PUSCH transmission is scheduled in the active BWP based at least in part on the DCI.

In some embodiments, determining the configuration may include determining the two or more active BWPs are to be active based at least in part on the active BWP indicator fields or the active BWP indicator field. In some embodiments, determining the configuration may include determining to transition to the one BWP being active or the more than one BWP being active based at least in part on the indication.

In some embodiments, determining the configuration may include determining to report radio link failure when a radio link quality for all resources in the set of resources for radio link monitoring for the two or more active BWPs is worse than the threshold Qout. In some embodiments, determining the configuration may include determining to report radio link failure when all resources in the set of resources for radio link monitoring for the BWP is worse than the threshold Qout.

In some embodiments, determining the configuration may include determining to dynamically report the one or more PHRs. In some embodiments, determining the configuration may include determining to generate the first CSI for the first BWP and determining to generate the second CSI for the second BWP.

Any one or more of the operations in FIG. 17 may be performed in a different order than shown and/or one or more of the operations may be performed concurrently in embodiments. Further, it should be understood that one or more of the operations may be omitted from and/or one or more additional operations may be added to the procedure 1700 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising determining configuration information for fragmented carriers with two or more active bandwidth parts (BWPs) within a serving cell, and generating a configuration message for transmission to a user equipment (UE), the configuration message including the configuration information.

Example 2 may include the method of example 1, wherein the configuration message is to configure a control resource set (CORESET) to be contained within one active BWP.

Example 3 may include the method of example 1, wherein the configuration message is to configure a control resource set (CORESET) to overlap with more than one active BWP.

Example 4 may include the method of example 1, wherein the configuration message is to configure each physical downlink control channel (PDCCH) candidate to be contained within one active BWP.

Example 5 may include the method of example 1, wherein the configuration message is to configure a physical downlink control channel (PDCCH) candidate to overlap with more than one active BWP.

Example 6 may include the method of example 1, wherein the configuration message is to configure the UE to monitor at most one active BWP for a physical downlink control channel (PDCCH).

Example 7 may include the method of example 1, wherein the configuration message is to configure the UE to monitor more than one active BWP for a physical downlink control channel (PDCCH).

Example 8 may include the method of example 1, the configuration message is to configure a frequency domain resource allocation (FDRA) of each physical downlink shared channel (PDSCH)/physical uplink shared channel (PUSCH) to overlap with only one active BWP.

Example 9 may include the method of example 1, wherein the configuration message is to configure a frequency domain resource allocation (FDRA) of each physical downlink shared channel (PDSCH)/physical uplink shared channel (PUSCH) to overlap with more than one active BWP for the FDRA.

Example 10 may include the method of example 1, wherein the configuration message includes downlink control information (DCI) to schedule physical downlink shared channel (PDSCH)/physical uplink shared channel (PUSCH) in another active BWP, wherein the configuration message is to be transmitted in one active BWP.

Example 11 may include the method of example 1, wherein the configuration message includes downlink control information (DCI) to schedule physical downlink shared channel (PDSCH)/physical uplink shared channel (PUSCH) in one active BWP, wherein the configuration message is to be transmitted in the one active BWP.

Example 12 may include the method of example 1, wherein the two or more active BWPs share one hybrid automatic repeat request (HARQ) process pool, and wherein each HARQ process for the two or more active BWPs have different HARQ process identifiers (IDs).

Example 13 may include the method of example 1, wherein each active BWP of the two or more active BWPs has an independent hybrid automatic repeat request (HARQ) process pool, wherein HARQ processes within a same active BWP have different HARQ process IDs, and wherein different HARQ processes in different active BWPs have the same HARQ process ID.

Example 14 may include the method of example 1, wherein a maximum number of hybrid automatic repeat request (HARQ) processes is sixteen across the two or more active BWPs.

Example 15 may include the method of example 1, wherein a maximum number of hybrid automatic repeat request (HARQ) processes is sixteen for each BWP within the two or more active BWPs.

Example 16 may include the method of example 1, wherein hybrid automatic repeat request (HARQ) retransmission for an HARQ transmission with the two or more active BWPs can be scheduled in a different active BWP than a BWP for the HARQ transmission.

Example 17 may include the method of example 1, wherein hybrid automatic repeat request (HARQ) retransmission for an HARQ transmission with the two or more active BWPs is scheduled within a same active BWP as the HARQ transmission.

Example 18 may include the method of example 1, wherein a bitwidth and encoding of a frequency domain resource assignment (FDRA) for the two or more active BWPs considers a union of the two or more active BWPs.

Example 19 may include the method of example 1, wherein a bitwidth and encoding of a frequency domain resource assignment (FDRA) for the two or more active BWPs considers the two or more active BWPs and frequency between the two or more active BWPs.

Example 20 may include the method of example 1, wherein the configuration message includes a number of active BWP indicator fields equal to a number of the two or more active BWPs, and wherein each BWP indicator field of the BWP indicator fields indicates a BWP to be active.

Example 21 may include the method of example 1, wherein the configuration message includes an active BWP indicator field of four bits, and wherein each bit of the active BWP indicator field indicates a corresponding BWP to be active.

Example 22 may include the method of example 1, wherein the configuration message includes an indication to transition to the one BWP being active or the more than one BWP being active.

Example 23 may include the method of example 1, wherein each BWP of the two or more BWPs has an own physical downlink shared channel (PDSCH), and wherein a virtual resource block (VRB) to physical resource block (PRB) mapping is generated for each BWP.

Example 24 may include the method of example 1, wherein the two or more BWPs have one physical downlink shared channel (PDSCH), and wherein physical resource blocks of the two or more BWPs are concatenated.

Example 25 may include the method of example 24, wherein a size of resource block (RB) bundles for the two or more BWPs is two RBs or four RBs.

Example 26 may include the method of example 24, wherein a size of resource block (RB) bundles for the two or more BWPs is greater than four RBs.

Example 27 may include the method of any of examples 23-26, wherein the VRB to PRB mapping includes interleaving.

Example 28 may include the method of any of examples 23-26, wherein the VRB to PRB mapping is non-interleaved.

Example 29 may include the method of example 1, wherein the configuration message is to configure radio link failure to be indicated when all resources in a set of resources for radio link monitoring for the two or more active BWPs is worse than a threshold Qout.

Example 30 may include the method of example 1, wherein the configuration message is to configure radio link failure to be indicated when all resources in the set of resources for radio link monitoring for the BWP is worse than a threshold Qout.

Example 31 may include the method of example 1, wherein frequency domain resource allocation (FDRA) of each physical uplink shared channel (PUSCH) for the two or more active BWPs overlaps with only one active BWP.

Example 32 may include the method of example 31, wherein the configuration message is to be transmitted in a first BWP of the two or more active BWPs, and wherein the configuration message includes downlink control information (DCI) that schedules PUSCH in a second BWP of the two or more active BWPs.

Example 33 may include the method of example 31, wherein the configuration message is to be transmitted in a BWP of the two or more active BWPs, and wherein the configuration message includes downlink control information (DCI) that schedules PUSCH in the BWP of the two or more active BWPs.

Example 34 may include the method of example 1, wherein frequency domain resource allocation (FDRA) of each physical uplink shared channel (PUSCH) for the two or more active BWPs overlaps with more than one active BWP.

Example 35 may include the method of example 1, wherein a combined power headroom report (PHR) procedure is to be performed for the two or more active BWPs, and wherein a per UE configured transmitted power Pc, max is to be utilized for the PHR.

Example 36 may include the method of example 1, wherein power headroom reporting is to be performed on a per BWP basis.

Example 37 may include the method of example 36, wherein a per BWP Pc,max value is static.

Example 38 may include the method of example 36, wherein a per BWP Pc, max value is upper bounded by a per UE Pc, max value.

Example 39 may include the method of example 38, wherein the configuration message is to configure the UE to dynamically report one or more power headroom reports (PHRs).

Example 40 may include the method of example 1, wherein each active BWP of the two or more active BWPs are to have separate physical uplink control channel (PUSCH)/sounding reference signal (SRS) frequency domain resource allocation.

Example 41 may include the method of example 1, wherein physical uplink control channel (PUSCH)/sounding reference signal (SRS) frequency domain resource allocation for the two or more active BWPs cross two active BWPs of the two or more active BWPs.

Example 42 may include the method of example 1, wherein frequency hopping is allowed only in an active BWP of the two or more active BWPs.

Example 43 may include the method of example 1, wherein frequency hopping is allowed across two active BWPs of the two or more active BWPs.

Example 44 may include the method of example 1, wherein the configuration message includes a channel state information (CSI) configuration information element (IE), and wherein the CSI configuration IE includes a first field that indicates a first CSI is to be provided for a first BWP of the two or more BWPs, and a second field that indicates a second CSI is to be provided for a second BWP of the two or more BWPs.

Example 45 may include the method of example 1, wherein a channel state information (CSI) subband size is determined based at least in part on a maximum BWP size of the two or more active BWPs.

Example 46 may include the method of example 1, wherein a channel state information (CSI) subband size is determined based at least in part on a total size of the two or more active BWPs.

Example 47 may include the method of example 1, wherein a channel state information (CSI) subband size is determined based at least in part on a total number of physical resource blocks (PRBs) from a lowest PRB in the two or more active BWPs to a highest PRB in the two or more active BWPs in a frequency domain.

Example 48 may include the method of example 1, wherein a channel state information (CSI) subband allocation is allocated independently for each active BWP of the two or more active BWPs.

Example 49 may include the method of example 1, wherein a channel state information (CSI) subband allocation is allocated jointly across the two or more active BWPs excluding resource blocks between adjacent BWPs of the two or more active BWPs.

Example 50 may include the method of example 1, wherein a channel state information (CSI) subband allocation is allocated jointly across the two or more active BWPs including resource blocks between adjacent BWPs of the two or more active BWPs.

Example 51 may include the method of example 1, wherein the two or more active BWPs have a same numerology, or are tone aligned.

Example 52 may include the method of example 1, wherein only one active BWP of the two or more BWPs contains controlResourceSetZero, or only one active BWP of the two or more BWPs contains searchSpaceZero/searchSpaceSIB 1/searchSpaceOtherSystemInformation/pagingSearchSpace/ra-SearchSpace.

Example 53 may include the method of example 1, wherein a maximum of four control resource sets (CORESETs) are configured across the two or more active BWPs.

Example 54 may include the method of example 1, wherein PDSCH-TimeDomainResource AllocationList is same for the two or more active BWPs or configured for only one active BWP of the two or more active BWPs, the two or more active BWPs have a common or combined list of transmission configuration indicator (TCI) states, the two or more active BWPs have a same demodulation reference signal (DMRS) type, a same DMRS additional position, a same max length, a same scrambling identifier (ID), or a same phase tracing reference signal (PTRS), the two or more active BWPs have a same vrb-ToPRB-Interleaver size, the two or more active BWPs have a same resourceAllocation type, the two or more active BWPs have a same pdsch-AggregationFactor, the two or more active BWPs have a same rgb-Size, the two or more active BWPs have a same mes-Table, or the two or more active BWPs have a same physical resource block (PRB) configuration type.

Example 55 may include the method of example 1, wherein the two or more active BWPs have a common or combined list of physical uplink control channel (PUCCH) resources, a common PUCCH format configuration, a same multi-CSI-PUCCH-ResourceList, a same dl-DataToUL-ACK, a common or combined list of PUCCH-SpatialRelationInfo, a common or combined pucch-PowerControl, a same PUSCH operation, a same coherency type, a same maximum physical uplink shared channel (PUSCH) rank, a same resource block group (RBG) size, enabled or disabled pi/2-BPSK, a same physical uplink shared channel (PUSCH) demodulation reference signal (DMRS) configuration, a same PUSCH frequency hopping configuration, a same resource allocation type, a same pusch-TimeDomainAllocationList, a same pusch-AggregationFactor, a same mcs-table, or a same waveform.

Example 56 may include a method comprising identifying a configuration message for fragmented carriers with two or more active bandwidth parts (BWPs) within a serving cell, and determining a configuration for the two or more active BWPs based at least in part on the configuration message.

Example 57 may include the method of example 56, wherein the configuration message indicates a control resource set (CORESET) is included within one active BWP of the two or more active BWPs, and wherein determining the configuration includes determining to monitor the one active BWP for the CORESET.

Example 58 may include the method of example 56, wherein the configuration message indicates a control resource set (CORESET) overlaps with the more than one active BWP, and wherein determining the configuration includes determining to monitor the more than one active BWP for the CORESET.

Example 59 may include the method of example 56, wherein the configuration message indicates each physical downlink control channel (PDCCH) candidate for the two or more active BWPs is contained within one active BWP.

Example 60 may include the method of example 56, wherein the configuration message indicates that a physical downlink control channel (PDCCH) candidate overlaps with more than one active BWP of the two or more active BWPs.

Example 61 may include the method of example 56, wherein the configuration message indicates one active BWP of the two or more active BWPs to monitor for a physical downlink control channel (PDCCH), and wherein determining the configuration includes determining to monitor the one active BWP for the PDCCH.

Example 62 may include the method of example 56, wherein the configuration message indicates more than one active BWP of the two or more active BWPs to monitor for a physical downlink control channel (PDCCH), and wherein determining the configuration includes determining to monitor the more than one active BWP for the PDCCH.

Example 63 may include the method of example 56, wherein the configuration message indicates one active BWP for frequency domain resource allocation (FDRA) of a physical downlink shared channel (PDSCH)/physical uplink shared channel (PUSCH), and wherein determining the configuration includes determining to monitor the one active BWP for the FDRA.

Example 64 may include the method of example 56, wherein the configuration message indicates more than one active BWP for frequency domain resource allocation (FDRA) of a physical downlink shared channel (PDSCH)/physical uplink shared channel (PUSCH), and wherein determining the configuration includes determining to monitor the more than one active BWP for the FDRA.

Example 65 may include the method of example 56, wherein the configuration message includes downlink control information (DCI) for scheduling a physical downlink shared channel (PDSCH)/physical uplink shared channel (PUSCH) transmission, wherein the configuration message is received in a first active BWP of the two or more active BWPs, and wherein determining the configuration includes determining the PDSCH/PUSCH transmission is scheduled in a second active BWP of the two or more active BWPs based at least in part on the DCI.

Example 66 may include the method of example 56, wherein the configuration message includes downlink control information (DCI) for scheduling a physical downlink shared channel (PDSCH)/physical uplink shared channel (PUSCH) transmission, wherein the configuration message is received in an active BWP of the two or more active BWPs, and wherein determining the configuration includes determining the PDSCH/PUSCH transmission is scheduled in the active BWP based at least in part on the DCI.

Example 67 may include the method of example 56, wherein the two or more active BWPs share one hybrid automatic repeat request (HARQ) process pool, and wherein each HARQ process for the two or more active BWPs have different HARQ process identifiers (IDs).

Example 68 may include the method of example 56, wherein each active BWP of the two or more active BWPs has an independent hybrid automatic repeat request (HARQ) process pool, wherein HARQ processes within a same active BWP have different HARQ process IDs, and wherein different HARQ processes in different active BWPs have the same HARQ process ID.

Example 69 may include the method of example 56, wherein a maximum number of hybrid automatic repeat request (HARQ) processes is sixteen across the two or more active BWPs.

Example 70 may include the method of example 56, wherein a maximum number of hybrid automatic repeat request (HARQ) processes is sixteen for each BWP within the two or more active BWPs.

Example 71 may include the method of example 56, wherein hybrid automatic repeat request (HARQ) retransmission for an HARQ transmission with the two or more active BWPs are scheduled in a different active BWP than a BWP for the HARQ transmission.

Example 72 may include the method of example 56, wherein hybrid automatic repeat request (HARQ) retransmission for an HARQ transmission with the two or more active BWPs is scheduled within a same active BWP as the HARQ transmission.

Example 73 may include the method of example 56, wherein a bitwidth and encoding of a frequency domain resource assignment (FDRA) for the two or more active BWPs considers a union of the two or more active BWPs.

Example 74 may include the method of example 56, wherein a bitwidth and encoding of a frequency domain resource assignment (FDRA) for the two or more active BWPs considers the two or more active BWPs and frequency between the two or more active BWPs.

Example 75 may include the method of example 56, wherein the configuration message includes a number of active BWP indicator fields equal to a number of the two or more active BWPs, wherein each BWP indicator field of the BWP indicator fields indicates a BWP to be active, and wherein determining the configuration includes determining the two or more active BWPs are to be active based at least in part on the active BWP indicator fields.

Example 76 may include the method of example 56, wherein the configuration message includes an active BWP indicator field of four bits, wherein each bit of the active

BWP indicator field indicates a corresponding BWP to be active, and wherein determining the configuration includes determining the two or more active BWPs are to be active based at least in part on the active BWP indicator field.

Example 77 may include the method of example 56, wherein the configuration message includes an indication to transition to one BWP being active or more than one BWP being active, and wherein determining the configuration includes determining to transition to the one BWP being active or the more than one BWP being active based at least in part on the indication.

Example 78 may include the method of example 56, wherein each BWP of the two or more BWPs has an own physical downlink shared channel (PDSCH), and wherein a virtual resource block (VRB) to physical resource block (PRB) mapping is generated for each BWP.

Example 79 may include the method of example 56, wherein the two or more BWPs have one physical downlink shared channel (PDSCH), and wherein physical resource blocks of the two or more BWPs are concatenated.

Example 80 may include the method of example 79, wherein a size of resource block (RB) bundles for the two or more BWPs is two RBs or four RBs.

Example 81 may include the method of example 79, wherein a size of resource block (RB) bundles for the two or more BWPs is greater than four RBs.

Example 82 may include the method of any of examples 78-81, wherein the VRB to PRB mapping includes interleaving.

Example 83 may include the method of any of examples 78-81, wherein the VRB to PRB mapping is non-interleaved.

Example 84 may include the method of example 56, wherein the configuration message includes an indication that radio link failure is to be indicated when all resources in a set of resources for radio link monitoring for the two or more active BWPs is worse than a threshold Qout, and wherein determining the configuration includes determining to report radio link failure when a radio link quality for all resources in the set of resources for radio link monitoring for the two or more active BWPs is worse than the threshold Qout.

Example 85 may include the method of example 56, wherein the configuration message includes an indication that radio link failure is to be indicated when all resources in a set of resources for radio link monitoring for a BWP is worse than a threshold Qout, and wherein determining the configuration includes determining to report radio link failure when all resources in the set of resources for radio link monitoring for the BWP is worse than the threshold Qout.

Example 86 may include the method of example 56, wherein frequency

domain resource allocation (FDRA) of each physical uplink shared channel (PUSCH) for the two or more active BWPs overlaps with only one active BWP.

Example 87 may include the method of example 86, wherein the configuration message is received in a first BWP of the two or more active BWPs, and wherein the configuration message includes downlink control information (DCI) that schedules PUSCH in a second BWP of the two or more active BWPs.

Example 88 may include the method of example 86, wherein the configuration message is received in a BWP of the two or more active BWPs, and wherein the configuration message includes downlink control information (DCI) that schedules PUSCH in the BWP of the two or more active BWPs.

Example 89 may include the method of example 56, wherein frequency domain resource allocation (FDRA) of each physical uplink shared channel (PUSCH) for the two or more active BWPs overlaps with more than one active BWP.

Example 90 may include the method of example 56, wherein a combined power headroom report (PHR) procedure is performed for the two or more active BWPs, and wherein a per UE configured transmitted power Pc, max is to be utilized for the PHR.

Example 91 may include the method of example 56, wherein power headroom reporting is to be performed on a per BWP basis.

Example 92 may include the method of example 91, wherein a per BWP Pc,max value is static.

Example 93 may include the method of example 91, wherein a per BWP Pc, max value is upper bounded by a per UE Pc, max value.

Example 94 may include the method of example 93, wherein the configuration message indicates that one or more power headroom reports (PHRs) are to be dynamically reported, and wherein determining the configuration includes determining to dynamically report the one or more PHRs.

Example 95 may include the method of example 56, wherein each active BWP of the two or more active BWPs are to have separate physical uplink control channel (PUSCH)/sounding reference signal (SRS) frequency domain resource allocation.

Example 96 may include the method of example 56, wherein physical uplink control channel (PUSCH)/sounding reference signal (SRS) frequency domain resource allocation for the two or more active BWPs cross two active BWPs of the two or more active BWPs.

Example 97 may include the method of example 56, wherein frequency hopping is allowed only in an active BWP of the two or more active BWPs.

Example 98 may include the method of example 56, wherein frequency hopping is allowed across two active BWPs of the two or more active BWPs.

Example 99 may include the method of example 56, wherein the configuration message includes a channel state information (CSI) configuration information element (IE), and wherein the CSI configuration IE includes a first field that indicates a first CSI is to be provided for a first BWP of the two or more BWPs and a second field that indicates a second CSI is to be provided for a second BWP of the two or more BWPs, and wherein determining the configuration includes determining to generate the first CSI for the first BWP and determining to generate the second CSI for the second BWP.

Example 100 may include the method of example 56, wherein a channel state information (CSI) subband size is determined based at least in part on a maximum BWP size of the two or more active BWPs.

Example 101 may include the method of example 56, wherein a channel state information (CSI) subband size is determined based at least in part on a total size of the two or more active BWPs.

Example 102 may include the method of example 56, wherein a channel state information (CSI) subband size is determined based at least in part on a total number of physical resource blocks (PRBs) from a lowest PRB in the two or more active BWPs to a highest PRB in the two or more active BWPs in a frequency domain.

Example 103 may include the method of example 56, wherein a channel state information (CSI) subband allocation is allocated independently for each active BWP of the two or more active BWPs.

Example 104 may include the method of example 56, wherein a channel state information (CSI) subband allocation is allocated jointly across the two or more active BWPs excluding resource blocks between adjacent BWPs of the two or more active BWPs.

Example 105 may include the method of example 56, wherein a channel state information (CSI) subband allocation is allocated jointly across the two or more active BWPs including resource blocks between adjacent BWPs of the two or more active BWPs.

Example 106 may include the method of example 56, wherein the two or more active BWPs have a same numerology, or are tone aligned.

Example 107 may include the method of example 56, wherein only one active BWP contains controlResourceSetZero, or only one active BWP contains searchSpaceZero/searchSpaceSIB 1/searchSpaceOtherSystemInformation/pagingSearchSpace/ra-SearchSpace.

Example 108 may include the method of example 56, wherein a maximum of four control resource sets (CORESETs) are configured across the two or more active BWPs.

Example 109 may include the method of example 56, wherein PDSCH-TimeDomainResourceAllocationList is same for the two or more active BWPs or configured for only one active BWP of the two or more active BWPs, the two or more active BWPs have a common or combined list of transmission configuration indicator (TCI) states, the two or more active BWPs have a same demodulation reference signal (DMRS) type, a same DMRS additional position, a same max length, a same scrambling identifier (ID), or a same phase tracing reference signal (PTRS), the two or more active BWPs have a same vrb-ToPRB-Interleaver size, the two or more active BWPs have a same resourceAllocation type, the two or more active BWPs have a same pdsch-AggregationFactor, the two or more active BWPs have a same rgb-Size, the two or more active BWPs have a same mes-Table, or the two or more active BWPs have a same physical resource block (PRB) configuration type.

Example 110 may include the method of example 56, wherein the two or more active BWPs have a common or combined list of physical uplink control channel (PUCCH) resources, a common PUCCH format configuration, a same multi-CSI-PUCCH-ResourceList, a same dl-DataToUL-ACK, a common or combined list of PUCCH-SpatialRelationInfo, a common or combined pucch-PowerControl, a same PUSCH operation, a same coherency type, a same maximum physical uplink shared channel (PUSCH) rank, a same resource block group (RBG) size, enabled or disabled pi/2-BPSK, a same physical uplink shared channel (PUSCH) demodulation reference signal (DMRS) configuration, a same PUSCH frequency hopping configuration, a same resource allocation type, a same pusch-TimeDomainAllocationList, a same pusch-AggregationFactor, a same mcs-table, or a same waveform.

Example 111 may include an apparatus comprising means to perform one or more elements of a method described in or related to any of examples 1-110, or any other method or process described herein.

Example 112 may include one or more non-transitory computer-readable media comprising instructions to cause an electronic device, upon execution of the instructions by one or more processors of the electronic device, to perform one or more elements of a method described in or related to any of examples 1-110, or any other method or process described herein.

Example 113 may include an apparatus comprising logic, modules, or circuitry to perform one or more elements of a method described in or related to any of examples 1-110, or any other method or process described herein.

Example 114 may include a method, technique, or process as described in or related to any of examples 1-110, or portions or parts thereof.

Example 115 may include an apparatus comprising: one or more processors and one or more computer-readable media comprising instructions that, when executed by the one or more processors, cause the one or more processors to perform the method, techniques, or process as described in or related to any of examples 1-110, or portions thereof.

Example 116 may include a signal as described in or related to any of examples 1-110, or portions or parts thereof.

Example 117 may include a datagram, information element, packet, frame, segment, PDU, or message as described in or related to any of examples 1-110, or portions or parts thereof, or otherwise described in the present disclosure.

Example 118 may include a signal encoded with data as described in or related to any of examples 1-110, or portions or parts thereof, or otherwise described in the present disclosure.

Example 119 may include a signal encoded with a datagram, IE, packet, frame, segment, PDU, or message as described in or related to any of examples 1-110, or portions or parts thereof, or otherwise described in the present disclosure.

Example 120 may include an electromagnetic signal carrying computer-readable instructions, wherein execution of the computer-readable instructions by one or more processors is to cause the one or more processors to perform the method, techniques, or process as described in or related to any of examples 1-110, or portions thereof.

Example 121 may include a computer program comprising instructions, wherein execution of the program by a processing element is to cause the processing element to carry out the method, techniques, or process as described in or related to any of examples 1-110, or portions thereof.

Example 122 may include a signal in a wireless network as shown and described herein.

Example 123 may include a method of communicating in a wireless network as shown and described herein.

Example 124 may include a system for providing wireless communication as shown and described herein.

Example 125 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
identify a configuration message for fragmented carriers with two or more active bandwidth parts (BWPs) within a serving cell; and
identify a configuration for the two or more active BWPs based at least in part on the configuration message.

2. The one or more non-transitory, computer-readable media of claim 1, wherein the configuration message indicates a control resource set (CORESET) is included within one active BWP of the two or more active BWPs, and wherein to determine the configuration includes to determine to monitor the one active BWP for the CORESET.

3. The one or more non-transitory, computer-readable media of claim 1, wherein the configuration message indicates a control resource set (CORESET) overlaps with the more than one active BWP, and wherein to determine the configuration includes to determine to monitor the more than one active BWP for the CORESET.

4. The one or more non-transitory, computer-readable media of claim 1, wherein the configuration message indicates each physical downlink control channel (PDCCH) candidate for the two or more active BWPs is contained within one active BWP.

5. The one or more non-transitory, computer-readable media of claim 1, wherein the configuration message indicates that a physical downlink control channel (PDCCH) candidate overlaps with more than one active BWP of the two or more active BWPs.

6. The one or more non-transitory, computer-readable media of claim 1, wherein the configuration message indicates one active BWP of the two or more active BWPs to monitor for a physical downlink control channel (PDCCH), and wherein to determine the configuration includes to determine to monitor the one active BWP for the PDCCH.

7. The one or more non-transitory, computer-readable media of claim 1, wherein the configuration message indicates the more than one active BWP of the two or more active BWPs to monitor for a physical downlink control channel (PDCCH), and wherein to determine the configuration includes to determine to monitor the more than one active BWP for the PDCCH.

8. The one or more non-transitory, computer-readable media of claim 1, wherein the configuration message indicates one active BWP for frequency domain resource allocation (FDRA) of a physical downlink shared channel (PDSCH)/physical uplink shared channel (PUSCH), and wherein to determine the configuration includes to determine to monitor the one active BWP for the FDRA.

9. The one or more non-transitory, computer-readable media of claim 1, wherein the configuration message indicates more than one active BWP for a frequency domain resource allocation (FDRA) of a physical downlink shared channel (PDSCH)/physical uplink shared channel (PUSCH), and wherein to determine the configuration includes to determine to monitor the more than one active BWP for the FDRA.

10. The one or more non-transitory, computer-readable media of claim 1, wherein the configuration message includes downlink control information (DCI) for scheduling a physical downlink shared channel (PDSCH)/physical uplink shared channel (PUSCH) transmission, wherein the configuration message is received in a first active BWP of the two or more active BWPs, and wherein to determine the configuration includes to determine the PDSCH/PUSCH transmission is scheduled in a second active BWP of the two or more active BWPs based at least in part on the DCI.

11. A method comprising:
identifying configuration information for fragmented carriers with two or more active bandwidth parts (BWPs) within a serving cell; and
generating a configuration message for transmission to a user equipment (UE), the configuration message including the configuration information.

12. The method of claim 11, wherein the configuration message is to configure a control resource set (CORESET) to be contained within one active BWP.

13. The method of claim 11, wherein the configuration message is to configure a control resource set (CORESET) to overlap with more than one active BWP.

14. The method of claim 11, wherein the configuration message is to configure each physical downlink control channel (PDCCH) candidate to be contained within one active BWP.

15. The method of claim 11, wherein the configuration message is to configure a physical downlink control channel (PDCCH) candidate to overlap with more than one active BWP.

16. The method of claim 11, wherein the configuration message is to configure the UE to monitor at most one active BWP for a physical downlink control channel (PDCCH).

17. An apparatus comprising:
processing circuitry to:
identify a configuration message for fragmented carriers with two or more active bandwidth parts (BWPs) within a serving cell;
identify a configuration for an uplink message based at least in part on the configuration message; and
generate the uplink message for transmission within the serving cell based at least in part on the configuration; and
interface circuitry coupled with the processing circuitry, the interface circuitry to enable communication.

18. The apparatus of claim 17, wherein the configuration message indicates a control resource set (CORESET) is included within one active BWP of the two or more active BWPs, and wherein to determine the configuration includes to determine to monitor the one active BWP for the CORESET.

19. The apparatus of claim 17, wherein the configuration message includes downlink control information (DCI) to schedule physical downlink shared channel (PDSCH)/physical uplink shared channel (PUSCH) in one active BWP, wherein the configuration message is to be transmitted in the one active BWP.

20. The apparatus of claim 17, wherein the two or more active BWPs share one hybrid automatic repeat request (HARQ) process pool, and wherein each HARQ process for the two or more active BWPs have different HARQ process identifiers (IDs).
